(19) United States
(12) Patent Application Publication
(10) Pub. No.: US 2024/0398192 A1
(43) Pub. Date: Dec. 5, 2024

(54) CLEANING APPARATUS

(71) Applicant: TINECO INTELLIGENT TECHNOLOGY CO., LTD., Suzhou City, Jiangsu (CN)

(72) Inventors: Shuwei GUO, Suzhou City (CN); Weidong LIU, Suzhou City (CN); Zhen HAN, Suzhou City (CN); Peng XIA, Suzhou City (CN); Yisong WANG, Suzhou City (CN); Chunhao WU, Suzhou City (CN); Zhen CHEN, Suzhou City (CN); Chunfeng ZHOU, Suzhou City (CN)

(73) Assignee: TINECO INTELLIGENT TECHNOLOGY CO., LTD., Suzhou City, Jiangsu (CN)

(21) Appl. No.: 18/697,412

(22) PCT Filed: Sep. 2, 2022
(86) PCT No.: PCT/CN2022/116909

§ 371 Date: Mar. 29, 2024

(30) Foreign Application Priority Data
Sep. 30, 2021 (CN) 202111162801.4
Sep. 30, 2021 (CN) 202111164044.4
Sep. 30, 2021 (CN) 202111166131.3
Dec. 24, 2021 (CN) 202123299803.6

(51) Int. Cl. A47L 11/30; A47L 11/33; A47L 11/34; A47L 11/40

(52) U.S. Cl. CPC A47L 11/302; A47L 11/33; A47L 11/34; A47L 11/4016; A47L 11/4041; A47L 11/4094

(57) ABSTRACT

Provided in the present disclosure are a cleaning apparatus, a cleaning device, and a changeover valve assembly. The cleaning apparatus includes a main body, a vacuum motor and a heating air output assembly, where an axial direction of the vacuum motor is parallel to a forward direction of the main body, an air inlet end of the vacuum motor is arranged on one side of the vacuum motor facing the forward direction, and projections of the air inlet end of the vacuum motor and the heating air outlet assembly on a horizontal plane at least partially coincide, such that the efficiency of sewage recovery can be improved, and sewage residue in an area that is cleaned is thus reduced.

The present disclosure claims the priorities of Chinese Patent Application No. 202111164044.4, filed on Sep. 30, 2021, entitled “Cleaning Device and Changeover Valve Assembly”, Chinese Patent Application No. 202111166131.3, filed on Sep. 30, 2021, entitled “Cleaning Apparatus”, Chinese Patent Application No. 202111162801.4, filed on Sep. 30, 2021, entitled “Cleaning Apparatus, Roller Brush Assembly and Handle”, and Chinese Patent Application No. 202123299803.6, filed on Dec. 24, 2021, entitled “Cleaning Apparatus, Collecting Apparatus and Filter assembly”, which are hereby incorporated by reference in their entireties.

### FIELD

The present disclosure relates to the technical field of cleaning device, and in particular to a cleaning apparatus, a cleaning device and a changeover valve assembly.

### BACKGROUND

With the development of social productivity, people's living standards have also been improved. On the premise that the material foundation is guaranteed, people begin to use various tools to reduce labor and improve the quality of life. Household cleaning device emerges at the historic moment, and becomes increasingly simple and intelligent. Taking a washer (a cleaning machine) as an example, the application of accessory brushes has been added to the washer, which is key to the optimization and distribution of waterways in the entire machine, since it is closely related to installation, cost and reliability. At present, the accessory waterway and the roller brush waterway on the market are controlled separately. The waterways are separate and complicated, and the accessories are plug-and-play, leading to poor reliability, and prone to leakage or failure.

### SUMMARY

In order to solve the problems existing in the prior arts, the present disclosure provides a cleaning apparatus, a cleaning device and a changeover valve assembly.

In a first aspect, the present disclosure provides a cleaning apparatus that can improve sewage recovery efficiency and reduce sewage residue in the area that is being cleaned.

The cleaning apparatus of the present disclosure includes a main body, a vacuum motor and a heating air outlet assembly, an axial direction of the vacuum motor is parallel to a forward direction of the main body, an air inlet end of the vacuum motor is arranged on one side of the vacuum motor facing the forward direction, and projections of the air inlet end of the vacuum motor and the heating air outlet assembly on a horizontal plane at least partially coincide.

In one embodiment, an axis of the air inlet end of the vacuum motor coincides with an axis of the heating air outlet assembly.

In one embodiment, the cleaning apparatus further includes a sewage bucket, the air inlet end of the vacuum motor is arranged below an air outlet end of the sewage bucket, and the air inlet end of the vacuum motor has an elbow structure.

In one embodiment, the heating air outlet assembly includes an air outlet casing and a heater arranged on the air outlet casing, one side of the air outlet casing is connected with the air outlet of the vacuum motor and another side forms an air outlet portion, and the heater is arranged between the air outlet of the vacuum motor and the air outlet portion.

In one embodiment, the air outlet of the vacuum motor is provided with an air outlet hood, the air outlet hood is connected with the air outlet and the heating air outlet assembly, to guide outlet air surrounding the air outlet vertically downward directing toward the heating air outlet assembly.

In one embodiment, the main body is provided with a roller brush installation portion, the air outlet portion of the heating air outlet assembly is arranged behind the roller brush installation portion in the forward direction of the main body, and the air outlet portion of the heating air outlet assembly is deflected in a direction away from the roller brush installation portion.

In one embodiment, an orthographic projection of the air outlet portion of the heating air outlet assembly in a first plane is a first projection, an included angle between a top of the first projection or a tangent line of the top and the forward direction of the main body is 5° to 20°, and the first plane is parallel to the forward direction of the main body and perpendicular to an extending direction of the roller brush installation portion.

In one embodiment, the included angle between the top of the first projection or the tangent line of the top and the forward direction of the main body is 7° to 10°.

In one embodiment, the air outlet portion includes a plurality of air outlet holes arranged in an array, the air outlet portion has two opposite ends along a width direction of the main body, and the air outlet holes of at least one end are configured to discharge air in a direction away from the other end.

In one embodiment, an air outlet angle of the air outlet hole at one end of the air outlet portion is a first value, the air outlet angle of the air outlet hole at the other end of the air outlet portion is a second value, and the air outlet angle of the air outlet hole is an included angle between an air outlet direction of the air outlet hole and the width direction of the main body.

In one embodiment, the first value and the second value are equal fixed values; or, the first value and the second value are unequal fixed values;
or, at least one of the first value and the second value gradually decreases in a direction away from the other end of the air outlet portion.

In one embodiment, the air outlet angle of the air outlet hole of at least one end is 45° to 85°.

In one embodiment, the air outlet angle of the air outlet hole of at least one end is 55° to 65°.

In one embodiment, a proportion of a sum of flow areas of the air outlet holes at either end of the air outlet portion in flow areas of the air outlet portion is a predetermined value.

In one embodiment, the air outlet has two side walls oppositely arranged in the width direction of the main body, and at least one side wall is configured to guide air away from the other side wall.

In one embodiment, the heating air outlet assembly further includes a sealing member, and the sealing member is arranged between outer peripheral surfaces of both ends of the heater and the air outlet casing.

In one embodiment, the heated air outlet assembly further includes a temperature sensor, the air outlet casing is provided with a slot portion, the temperature sensor is arranged in the slot portion, and the sealing member is pressed on the temperature sensor.

In one embodiment, a buffer element is provided between the vacuum motor and the heating air outlet assembly, and a buffer element is provided between the main body and the heating air outlet assembly.

The cleaning apparatus of the present disclosure is provided with a suction port, a fluid channel and a sewage bucket connected in sequence on the main body. The axial direction of the vacuum motor is parallel to the forward direction of the main body. The air inlet end of the vacuum motor is arranged on one side of the vacuum motor adjacent to the air outlet end of the sewage bucket along axial direction of which, the air outlet end of the sewage bucket and the air inlet end of the vacuum motor are arranged adjacent and interconnected to each other; in this way, the suction port, the fluid channel, the sewage bucket and the vacuum motor can be communicated in sequence. The vacuum motor can form a negative pressure at the suction port, so that the air on the surface of the area to be cleaned and the sewage are sucked are sucked from the suction port under the negative pressure to enter the sewage bucket through the fluid channel. The sewage bucket can separate the air and sewage, so that the sewage is retained in the sewage bucket and the air is discharged into the vacuum motor through the air outlet end of the sewage bucket and the air inlet end of the vacuum motor to realize the sewage suction process; due to there is no need to connect the air inlet end of the vacuum motor and the air outlet end of the sewage bucket through pipelines, which can make the air flow between the sewage bucket and the vacuum motor smoother and avoid poor air inlet caused by the bending layout of the pipeline, and ensure that there is a sufficient pressure difference between the suction port and the external air environment, and that the suction port has sufficient sewage suction capacity, which can improve sewage recovery efficiency and reduce sewage residues in the area being cleaned.

In a second aspect, the present disclosure provides a cleaning device. The cleaning device of the present disclosure includes a body, a roller brush assembly and a changeover valve assembly; wherein the changeover valve assembly includes: a valve body, having a valve cavity in which a first waterway and a second waterway are formed;
a piston mechanism, located in the valve cavity and provided with a first sealing member and a second sealing member; wherein the piston mechanism is configured to perform a rectilinear motion between a first position and a second position in an extension direction of the valve cavity; and
a first elastic apparatus, configured to preload the piston mechanism in the first position;
when in the first position, the first sealing member seals the second waterway, and the second sealing member enables an opening of the first waterway;
when the piston mechanism overcomes an elastic force of the first elastic apparatus and moves to the second position after receiving an external force, the second sealing member seals the first waterway, and the first sealing member enable an opening of the second waterway;
the first waterway is configured to supply water to the roller brush assembly.

In one embodiment, the valve body is provided with a water inlet, a first water outlet and a second water outlet respectively communicated with the valve cavity; the first waterway is surrounded by the water inlet, part of the valve cavity and the first water outlet; and the second waterway is surrounded by the water inlet, part of the valve cavity and the second water outlet.

In one embodiment, the valve body is cylindrical, the valve body is further provided with a first bypass pipe, and the first bypass pipe communicates with the valve cavity through the water inlet; and/or, the valve body is provided with a second bypass pipe, and the second bypass pipe communicates with the valve cavity through the first water outlet; and/or, the second water outlet is an opening at one end of the valve cavity.

In one embodiment, the water inlet is located on the valve body at a position between the first water outlet and the second water outlet.

In one embodiment, the first sealing member is configured to form an end face seal or a radial seal with the valve cavity; and the second sealing member is configured to form an end face seal or a radial seal with the valve cavity.

In one embodiment, the piston mechanism includes a piston rod, and the first sealing member is arranged at an end position of the piston rod; an inner wall of the valve chamber is provided with one ring of a first flange extending radially inward at a position located between the water inlet and the second water outlet; and the first sealing member is configured to contact and seal with an end face of the first flange.

In one embodiment, a middle position of an end of the piston rod is provided with a contact end for contacting against an outside, and the contact end passes through the end face of the first sealing member, and a stopping portion is formed at a position of an end of the contact end to prevent the first sealing member from being detached.

In one embodiment, the second sealing member is arranged at the other end of the piston rod, and the inner wall of the valve cavity is provided with one ring of a second flange extending radially inward at a position located between the water inlet and the first water outlet; and the second sealing member is configured to contact and seal with an end face of the second flange.

In one embodiment, the second sealing member is configured to contact and seal with the inner wall of the valve cavity located between the water inlet and the first water outlet.

In one embodiment, the second sealing member is an O-ring, the inner wall of the valve cavity is provided with a step groove penetrating to a position of the water inlet, and the O-ring is configured to enable an opening of the first waterway when moving to a position of the step groove.

In one embodiment, the first elastic apparatus is a first spring sleeved on the piston rod, one end of the first spring contacts against at apposition of the step groove, and the other end contacts against the piston rod.

In one embodiment, the valve body includes a first valve body and a second valve body assembled with the first valve body, and the piston mechanism is configured to perform a rectilinear motion in a valve cavity formed by the first valve body and the second valve body.

In one embodiment, the cleaning device further includes an accessory brush assembly detachably connected to the body, wherein the accessory brush assembly comprises a water inlet pipe connector, and the water inlet pipe connector is configured to insert into the second waterway of the valve cavity and push the piston mechanism to move from the first position to the second position.

In one embodiment, the water inlet pipe connector is provided with a third sealing member, and the third sealing member is configured to form a radial seal with the inner wall of the valve cavity, or to form an end face seal with the first flange provided on the inner wall of the valve cavity.

In one embodiment, the accessory brush assembly includes a base, the base is configured to be detachably connected with the body or the roller brush assembly, and further comprises a second elastic apparatus located between the water inlet pipe connector and the base; and the water inlet pipe connector is configured to move in an insertion direction of a water inlet pipe and the valve body under an elastic force of the second elastic apparatus.

In one embodiment, the elastic force of the second elastic apparatus is greater than the elastic force of the first elastic apparatus.

In one embodiment, the roller brush assembly includes a roller brush cover and a roller brush detachably connected to the body, and a cavity for accommodating the roller brush is enclosed by the roller brush cover and the body; the roller brush cover is provided with an accessory brush water pipe interface communicating with the second waterway; and the water inlet pipe connector is configured to extend into the valve cavity through the accessory brush water pipe interface.

In one embodiment, the body is provided with a main sewage suction channel, the roller brush cover is provided with a roller brush sewage suction channel, the roller brush sewage suction channel comprises a straight pipe section communicating with the main sewage suction channel, and an inclined section communicating with the straight pipe section; and the roller brush cover is further provided with an insertion interface communicating with the straight pipe section, and an accessory sewage suction joint in the accessory brush assembly is configured to extend into the straight pipe section from the insertion interface, and sealingly connect with the main sewage suction channel;
the roller brush cover is provided with a cover plate in an openable way, and the cover plate is configured to cover the accessory brush water pipe interface, and to seal the insertion interface.

In one embodiment, the roller brush sewage suction channel and the main sewage suction channel are sealingly connected.

In one embodiment, a fourth sealing member is provided at a position of an opening end of the main sewage suction channel, and the roller brush sewage suction channel is configured to form an end face seal with the first sealing member; and the accessory sewage suction joint is configured to form a radial seal with the first sealing member. In one embodiment, the roller brush cover comprises a first layer plate and a second layer plate, and the roller brush sewage suction channel is surrounded by the first layer plate and the second layer plate; and the roller brush sewage suction channel extends obliquely from an upper end of the roller brush cover to a lower end of the roller brush cover.

In one embodiment, the cleaning device is a carpet cleaning machine.

In a third aspect, the present disclosure provides a changeover valve assembly. The changeover valve assembly of the present disclosure includes:
a valve body, having a valve cavity in which a first waterway and a second waterway are formed;
a piston mechanism, located in the valve cavity and provided with a first sealing member and a second sealing member; wherein the piston mechanism is configured to perform a rectilinear motion between a first position and a second position in an extension direction of the valve cavity; and
a first elastic apparatus, configured to preload the piston mechanism in the first position;
when in the first position, the first sealing member seals the second waterway, and the second sealing member enables an opening of the first waterway;
when the piston mechanism overcomes an elastic force of the first elastic apparatus and moves to the second position after receiving an external force, the second sealing member seals the first waterway, and the first sealing member enable an opening of the second waterway.

In one embodiment, the valve body is provided with a water inlet, a first water outlet and a second water outlet respectively communicated with the valve cavity; the first waterway is surrounded by the water inlet, part of the valve cavity and the first water outlet; and the second waterway is surrounded by the water inlet, part of the valve cavity and the second water outlet

The cleaning device and the changeover valve assembly of the present disclosure have a simple structure. When the piston mechanism is driven by an external accessory to overcome the elastic force of the first elastic apparatus and move to the second position, the second waterway is opened and the first waterway is closed. When the external force is removed, it moves back to the first position under the restoring force of the first elastic apparatus, the first waterway opened, and the second waterway is closed. The rapid changing between different waterways is achieved.

In order to make the above-mentioned objects, features and advantages of the present disclosure more obvious and understandable, preferred embodiments are given below and described in detail with reference to the accompanying drawings.

### BRIEF DESCRIPTION OF THE DRAWINGS

In order to explain the technical solutions of the embodiments of the present disclosure more clearly, the drawings used in the embodiments will be briefly introduced below. The drawings here are incorporated into the specification and constitute one part of the specification. These drawings illustrate embodiments consistent with the present disclosure, which are used together with the description, serving to explain the technical solutions of the present disclosure. It should be understood that the following drawings only illustrate certain embodiments of the present disclosure, and therefore should not be regarded as limiting the scope. For those of ordinary skill in the art, other relevant drawings can also be obtained based on these drawings without exerting creative efforts.

FIG. 1 is a partial cross-sectional structural schematic diagram from one perspective when a cleaning device is in an accessory brush working mode provided by the present disclosure;

FIGS. 2 and 3 are respectively a front view and a rear view of an embodiment of a changeover valve assembly provided by the present disclosure;

FIG. 4 is a schematic cross-sectional structural diagram along the line A-A in FIG. 2;

FIG. 5 is a schematic cross-sectional structural diagram of an assembly of a changeover valve assembly and an accessory brush assembly when a piston mechanism is in a second position;

FIG. 6 is a schematic three-dimensional structural diagram of an accessory brush assembly;

FIG. 7 is a partial three-dimensional structural diagram of a cleaning device when a cover is closed;

FIG. 8 is a partial three-dimensional structural diagram of a cleaning device with the cover is opened;

FIG. 9 is a schematic three-dimensional structural diagram of a cleaning device shown in FIG. 7 with the roller brush cover hidden;

FIG. 10 is a partial cross-sectional structural schematic diagram from another perspective when a cleaning device provided by the present disclosure is in an accessory brush working mode;

FIG. 11 is a schematic cross-sectional structural diagram of another specific embodiment of a changeover valve assembly when a piston mechanism is in a first position;

FIG. 12 is a schematic cross-sectional structural diagram of a changeover valve assembly in FIG. 10 when a piston mechanism is in a second position;

FIG. 13 is a cross-sectional structural diagram of a cleaning apparatus provided by some embodiments of the present disclosure;

FIG. 14 is a partial cross-sectional structural diagram provided by some embodiments of the present disclosure;

FIG. 15 is a structural diagram of an air outlet casing of a cleaning apparatus provided by some embodiments of the present disclosure;

FIG. 16 is a cross-sectional structural diagram of a heating air outlet assembly of a cleaning apparatus provided by some embodiments of the present disclosure;

FIG. 17 is a cross-sectional structural diagram of an air outlet casing of a cleaning apparatus provided by some embodiments of the present disclosure;

FIG. 18 is an axial cross-sectional structural diagram of a heating air outlet assembly of a cleaning apparatus provided by some embodiments of the present disclosure;

FIG. 19 is another axial cross-sectional structural diagram of a heating air outlet assembly of a cleaning apparatus provided by some embodiments of the present disclosure;

FIG. 20 is a partial structural diagram of a cleaning apparatus of the cleaning apparatus provided by some embodiments of the present disclosure;

FIG. 21 is a cross-sectional structural diagram of a cleaning apparatus provided by some embodiments of the present disclosure;

FIG. 22 is a partial structural diagram of a cleaning apparatus in FIG. 21;

FIG. 23 is another partial structural diagram of a cleaning apparatus in FIG. 21;

FIG. 24 is a structural diagram of an elastic connection portion of a handle provided by some embodiments of the present disclosure;

FIG. 25 is a left partial structural diagram of a cleaning apparatus provided by some embodiments of the present disclosure;

FIG. 26 is a partial structural diagram of a cleaning apparatus at M in FIG. 25;

FIG. 27 is a partial structural diagram of a cleaning apparatus at N in FIG. 25;

FIG. 28 is a front structural diagram of a roller brush assembly provided by some embodiments of the present disclosure;

FIG. 29 is a cross-sectional structural diagram of a roller brush assembly provided by some embodiments of the present disclosure;

FIG. 30 is a cross-sectional structural diagram of a collection apparatus provided by an embodiment of the present disclosure;

FIG. 31 is a schematic diagram of an overall structure of a filter assembly provided by an embodiment of the present disclosure;

FIG. 32 is a cross-sectional structural diagram of a cleaning device provided by an embodiment of the present disclosure.

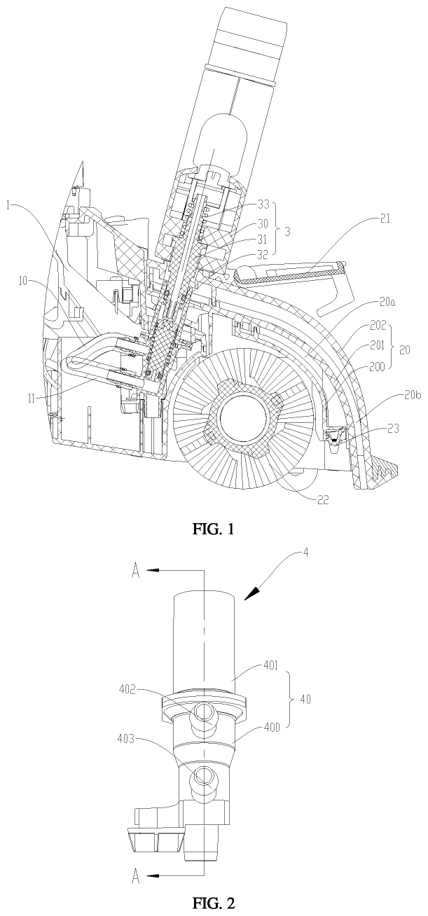

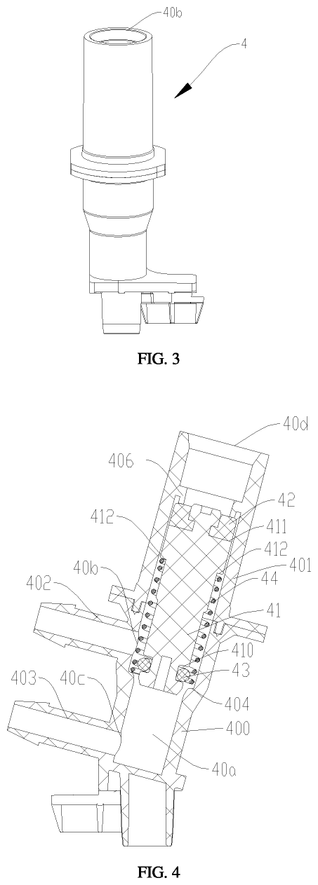

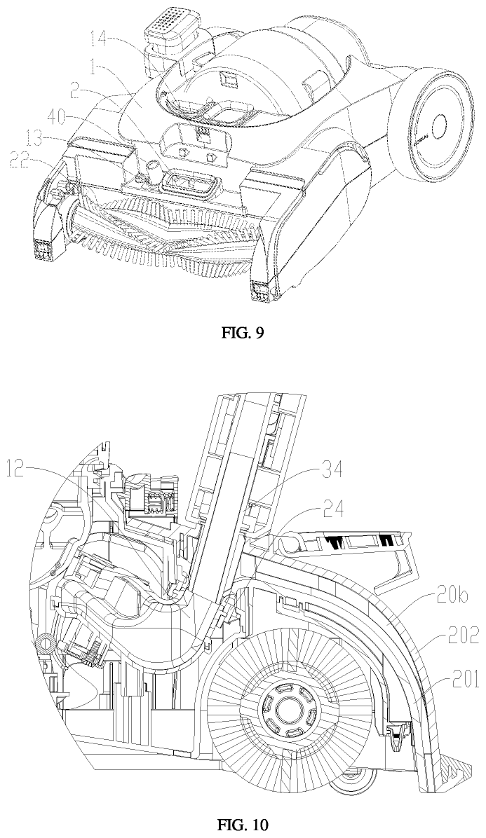

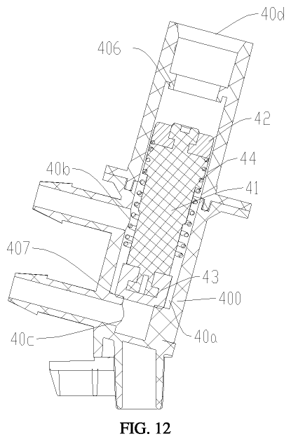

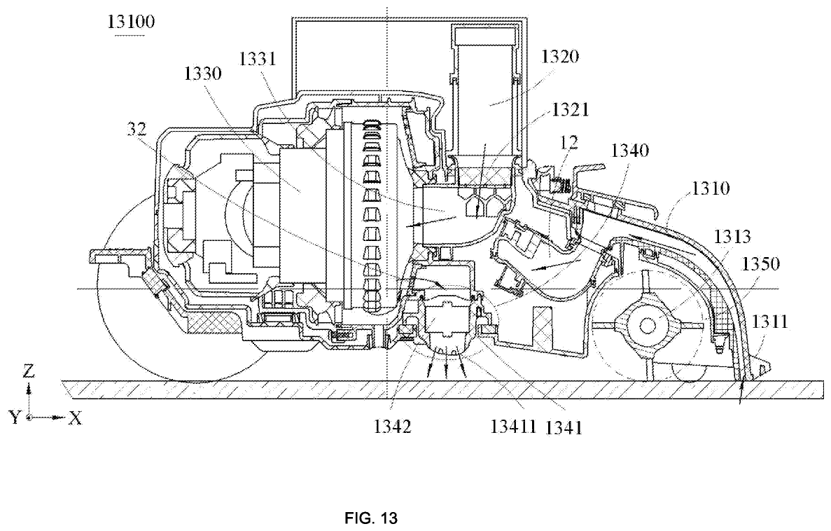

A one-to-one correspondence between the names and reference signs of each component in FIGS. 1 to 12 is:
1 body, 10 upstream side channel, 11 downstream side channel, 12 main sewage suction channel, 13 valve body through hole, 14 first slot, 2 roller brush assembly, 20 roller brush cover, 20a roller brush water supply channel, 20b roller brush sewage suction channel, 200 first layer plate, 201 second layer plate, 202 third layer plate, 203 accessory waterway installation port, 204 third slot, 205 sewage suction port, 206 buckle block, 207 positioning boss, 208 positioning block, 21 cover plate, 210 third elastic hook, 211 handle, 22 roller brush, 23 nozzle, 24 fourth sealing member, 25 fifth sealing member, 250 positioning groove, 3 accessory brush assembly, 30 base, 300 first elastic hook, 301 fifth axial limit ring surface, 31 water inlet pipe connector, 310 second circumferential sealing ring groove, 311 third axial limit ring surface, 312 sixth axial limit ring surface, 32 third sealing member, 33 second elastic apparatus, 34 suction pipe joint, 4 changeover valve assembly, 40 valve body, 40a valve cavity, 40b water inlet, 40c first water outlet, 40d second water outlet, 400 first valve body, 401 second valve body, 402 first bypass pipe, 403 second bypass pipe, 404 step groove, 405 fourth axial limit ring surface, 406 first flange, 407 second flange, 41 piston mechanism, 410 first circumferential sealing ring groove, 411 first axial limit ring surface, 412 second axial limit ring surface, 42 first sealing member, 43 second sealing member, 44 first elasticity apparatus. A one-to-one correspondence between the names and reference signs of each component in FIGS. 13 to 20 is: 13100 cleaning apparatus, 1310 main body, 1311 suction port, 1312 fluid channel, 1313 roller brush installation portion, 1320 sewage bucket, 1321 air outlet end, 1330 vacuum motor, 1331 air inlet end, 1332 air outlet, 1333 air outlet hood, 1340 heating air outlet assembly, 1341 air outlet casing, 13411 air outlet portion, 13411a air outlet hole, 13411b side wall, 13411c slot portion, 1342 heater, 1343 sealing member, 1350 roller brush, 1360 temperature sensor, 1370 buffer element.

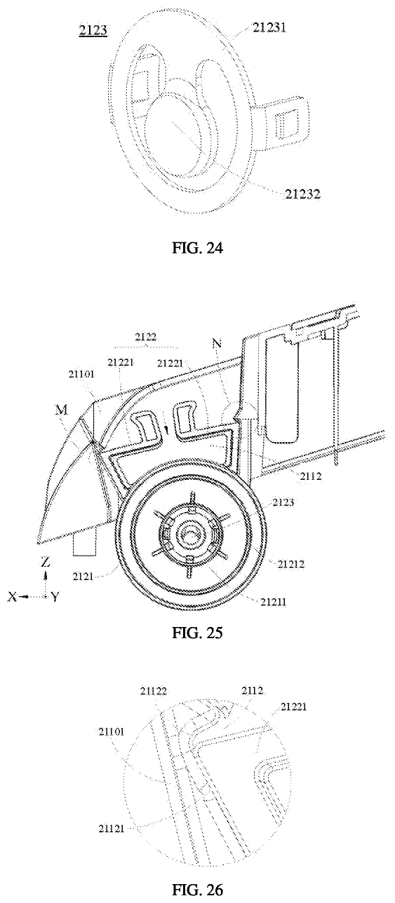

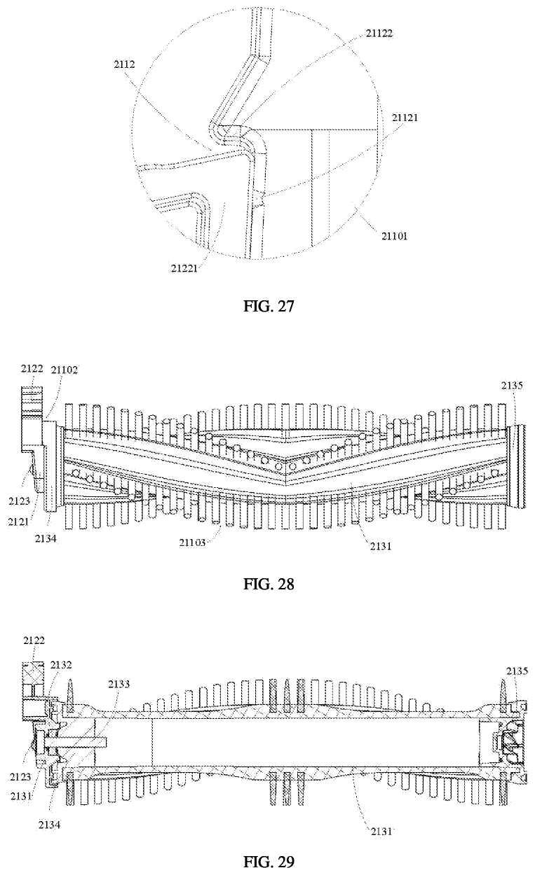

A one-to-one correspondence between the names and reference signs of each component in FIGS. 21 to 29 is:
21100 cleaning apparatus, 21101 main base, 2111 first installation portion, 2112 second installation portion, 21121 flange portion, 21122 buckle portion, 2114 coupling, 21102 handle, 2121 body connection portion, 21211 first installation cavity, 21212 second installation cavity, 2122 elastic handle portion, 21221 elastic arm portion, 2123 elastic connection portion, 21231 base body sub-portion, 21232 elastic piece sub-portion, 21103 roller brush, 2131 roller brush body, 2132 bearing, 2133 roller brush shaft, 2134 first end cap, 2135 second end cap.

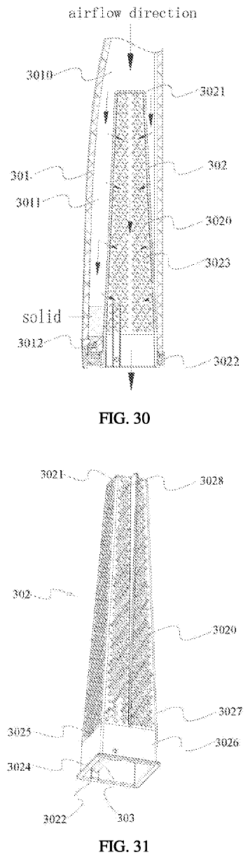

A one-to-one correspondence between the names and reference signs of each component in FIGS. 30 to 32 is:
301 container, 3010 negative pressure channel, 3011 collection cavity, 3012 extension portion, 302 filter assembly, 3020 through hole, 3021 first end, 3022 second end, 3023 filter cavity, 3024 limit flange, 3025 limit buckle, 3026 matching portion, 3027 filter portion, 3028 fool-proof structure, 303 handle, 304 body, 3040 sewage inlet channel, 3041 air outlet channel, 3042 motor assembly.

### DETAILED DESCRIPTION OF EXAMPLE EMBODIMENTS

For making the purposes, technical solutions and advantages of the embodiments of the present disclosure clearer, the technical solutions in the embodiments of the present disclosure will be clearly and completely described below in combination with the drawings in the embodiments of the present disclosure. It is apparent that the described embodiments are not all embodiments but part of embodiments of the present disclosure. All other embodiments obtained by those of ordinary skill in the art on the basis of the embodiments in the present disclosure without creative work shall fall within the scope of protection of the present disclosure.

In addition, the terms “first”, “second”, etc. used in the description and claims of the embodiments of the present disclosure and the above-mentioned drawings are used to distinguish similar objects, and are not necessarily used to describe a specific order or sequence. It is to be understood that the data so used may be interchangeable under appropriate circumstances so that the embodiments described herein can be practiced in sequences other than those illustrated or described herein.

The “multiple or several” mentioned in this article means two or more. It is to be understood that term “and/or” used in the present disclosure is only an association relationship describing associated objects and represents existence of three relationships. For example, A and/or B may represent three conditions, i.e., independent existence of A, coexistence of A and B and independent existence of B. In addition, character “/” in the present disclosure usually represents that previous and next associated objects form an “or” relationship.

The cleaning device of the present disclosure includes a changeover valve assembly, which cooperates with the accessory brush assembly to quickly switch between the roller brush working mode and the accessory brush working mode. For example, when the accessory brush assembly needs to be used, the accessory brush assembly can be plugged into the corresponding position of the cleaning device, and the waterway of the accessory brush assembly is opened through the changeover valve assembly, so that the clean water tank of the cleaning device can supply water to the accessory brush assembly.

The present disclosure here provides a changeover valve assembly, which includes a valve body having a valve cavity, in which a first waterway and a second waterway are formed through different openings. For example, in a specific embodiment, the valve body is respectively provided with a water inlet, a first water outlet, and a second water outlet communicating with the valve cavity. The first waterway is surrounded by the water inlet, part of the valve cavity and the first water outlet. The second waterway is surrounded by the water inlet, part of the valve cavity and the second water outlet.

The changeover valve assembly further includes a piston mechanism moving in the valve cavity, and a first sealing member and a second sealing member are provided on the piston mechanism. The piston mechanism is configured to perform a rectilinear motion between a first position and a second position in an extension direction of the valve cavity.

When the piston mechanism is in the first position, the first sealing member seals the above-mentioned second waterway, and the second sealing member opens the first waterway. That is to say, the external water source can enter through the water inlet and flow out through the first water outlet in the valve cavity. When the piston mechanism moves to the second position, the second sealing member seals the first waterway; the first sealing member opens the second waterway. The external water source can enter through the water inlet and flow out through the second water outlet in the valve cavity.

The changeover valve assembly further includes a first elastic apparatus, which is configured to pre-pressure the piston mechanism in the first position. When the piston mechanism receives an external force, the piston mechanism overcomes the elastic force of the first elastic apparatus and moves to the second position. When the external force disappears, the piston mechanism returns to the first position under the restoring force of the first elastic apparatus.

In order to facilitate a better understanding, taking two embodiments of a carpet washer (cleaning machine) as examples, the specific structures and working principle of the cleaning device and the changeover valve assumable provided on the cleaning device are described in detail with reference to FIGS. 1 to 12. Of course, the changeover valve assembly is not limited to use in cleaning device, but can also be applied to other devices with the similar functional requirements. In addition, the cleaning device can also be floor cleaning machines, vacuum cleaners and other device in addition to carpet cleaning machine.

### Embodiment 1

Referring to FIG. 1, in this embodiment, the cleaning device at least includes a body 1 and a roller brush assembly arranged on the body 1. During operation, clean water can be sprayed on the roller brush 22, so that the roller brush 22 can clean the stains on the floor that cannot be sucked away during the rotation. In addition, the roller brush assembly can also suck dust, debris and sewage after cleaning on the work surface.

The cleaning device has a clean water tank and a sewage tank. The main base water pump transports the water in the clean water tank to the spray mechanism through the water supply pipeline, and then sprays it on the roller brush 22 through the spray mechanism to clean or moisten the roller brush 22.

The roller brush assembly of the cleaning device at least includes a roller brush cover 20 and a roller brush 22; wherein the roller brush cover 20 is detachably connected to the body 1 of the cleaning device, and the roller brush cover 20 and the body 1 enclose a cavity for accommodating the roller brush 22. The roller brush 22 is detachably connected to the body 1.

The roller brush cover 20 may be a three-layer structure, which may include a first layer plate 200, a second layer plate 201, and a third layer plate 202, wherein the gap between the first layer plate 200 and the second layer plate 201 may be form the roller brush water supply channel 20a. The roller brush cover 20 is also detachably connected with a nozzle 23. The nozzle 23 communicates with the roller brush water supply channel 20a. The roller brush water supply channel 20a communicates with the main water supply channel. The main water supply channel can be a channel provided on the body 1 or a separate water pipe assembly.

The cleaning device further includes an accessory brush assembly 3, which is detachably connected to the body 1. The accessory brush assembly 3 also has an accessory brush water supply channel, and the accessory water supply channel also needs to communicate with the main water supply channel to supply water to the accessory brush of the accessory brush assembly 3.

Continuing to refer to FIG. 1, in order to switch between roller brush water supply and accessory brush water supply, the cleaning device of the present disclosure also includes a changeover valve assembly 4, and the changeover valve assembly 4 is configured to communicate the main water supply channel and the roller brush water supply channel 20a, or communicate the main water supply channel and the accessory brush water supply channel.

With reference to FIGS. 2 to 4, in this embodiment, the changeover valve assembly 4 includes a valve body 40, a piston mechanism and a first elastic apparatus 44.

The valve body 40 has a valve cavity 40a, a water inlet 40b, a first water outlet 40c and a second water outlet 40d that are communicated with the valve cavity 40a. The water inlet 40b is used to communicate the valve cavity 40a and the upstream side channel of the main water supply channel, and the first water outlet 40c is used to communicate the valve cavity 40a and the downstream side channel of the main water supply channel. Along the direction of water flow, the downstream side channel is located below the upstream side channel, that is, the water flows from the upstream side channel to the downstream side channel.

The valve body 40 is cylindrical. The valve body 40 is provided with a first bypass pipe 402 and a second bypass pipe 403. The first bypass pipe 402 communicates with the valve cavity 40a through the water inlet 40b, and the second bypass pipe 403 communicates with the valve cavity 40a through the first water outlet 40c, and the second water outlet 40d is an opening at one end of the valve cavity 40a. Such an arrangement can control the axial size of the valve body 40 within a smaller range, so that the overall size of the cleaning device can be smaller.

Specifically, the valve body 40 includes a first valve body 400 and a second valve body 401 that are spliced. The first valve body 400 and the second valve body 401 are end-face sealingly connected at the splicing point to form the valve cavity 40a. An annular sealing groove is provided on the joint surface of the first valve body 400, and the second valve body 401 is pressed against the joint surface of the first valve body 400 to squeeze part of the sealing ring protruding from the annular sealing groove, thereby achieving the end face seal connection relationship between the two.

In this embodiment, the second valve body 401 is made of elastic material, and a joint surface of which is raised to form an annular sealing ring. After the first valve body 400 and the second valve body 401 are assembled, the annular sealing ring is squeezed into the annular sealing groove and is squeezed continuedly, so that the first valve body 400 and the second valve body 401 are sealed and connected to form the valve cavity 40a.

In other embodiments, an elastic sealing gasket is provided between the splicing surfaces of the first valve body 400 and the second valve body 401, and then the two are fixedly connected through bolts.

The piston mechanism includes a piston rod 41, which is located in the valve cavity 40a and is provided with a first sealing member 42 and a second sealing member 43. The piston rod 41 is configured to perform a rectilinear motion between a first position and a second position in an extension direction of the valve cavity. It should be noted that the word “axial” used in this article to describe the cleaning device refers to the linear movement direction of the piston rod 41 in the valve cavity 40a, the word “circumferential” refers to the direction around the axial direction, and the “radial direction” refers to the direction perpendicular to the axial direction.

The piston mechanism includes a piston rod 41. A first sealing member 42 is provided at a position of the end of the piston rod; the inner wall of the valve cavity 40a is provided with one ring of a first flange 406 extending radially inward at a position located between the water inlet 40b and the second water outlet 40d; and the first sealing member 42 is configured to contact and seal with an end face of the first flange 406.

Specifically, one end portion of the piston rod 41 has a first circumferential sealing ring groove 410 and the other end portion has a first axial limit ring surface 411.

The second sealing member 43 is sleeved in the first circumferential sealing ring groove 410, and the first sealing member 42 is sleeved on the piston rod 41 and is in contact with the first axial limit ring surface 411.

When the piston rod 41 linearly moves to the second position in the valve cavity 40a, the second sealing member 43 is pressed against the piston rod 41 and part of the inner wall of the valve cavity 40a, so that the piston rod 41 and the valve body 40 form a radial seal connection.

When the piston rod 41 linearly moves to the first position in the valve cavity 40a, the first sealing member 42 is pre-pressed between the first flange 406 protrudingly provided on the inner wall of the valve cavity 40a and the first axial limit ring surface 411 of the piston rod 41 to form an end-face sealing connection between the piston rod 41 and the valve body 40.

In another embodiment, the first sealing member 42 may also be configured to completely cover one end of the piston rod 41.

The second sealing member 43 is an O-ring. The inner wall of the valve cavity 40a is provided with a step groove 404 that penetrates to the water inlet 40b. The O-ring is configured to move to the position of the step groove 404 to open the first waterway.

When the piston rod 41 is in the first position, the second sealing member 43 is located above the step groove 404, and there is a gap between the second sealing member 43 and the valve cavity 40a. After starting the main base water pump of the cleaning device, clean water flows into the valve cavity 4a through the water inlet 40b, then flows to the first water outlet 40c through the gap between the piston rod 41 and the inner wall of the valve cavity, and is finally transported to the downstream side channel of the main water supply channel though the first water outlet 40c. That is to say, the first waterway of the valve body is constituted by the water inlet 40b, the gap between the piston rod 41 and the inner wall of the valve cavity, and the first water outlet 40c.

The first elastic apparatus 44 is arranged in the valve cavity 40a and is configured to pre-pressure the piston rod 41 in the first position.

Specifically, the first elastic apparatus 44 is specifically a compression spring. The first elastic apparatus is sleeved on the piston rod 41 and is pre-pressed on the piston rod 41 and the valve body 40.

The piston rod 41 has a second axial limit ring surface 412. The inner wall of the valve cavity 40a of the valve body 40 is provided protrusively with a step groove 404. The first elastic apparatus 44 is pre-pressed between the second axial limit ring surface 412 and the step groove 404. Moreover, the step groove 404 is located between the water inlet 40b and the first water outlet 40c.

When in the first position, under the elastic force of the first elastic apparatus 44, the piston rod 41 and the valve body 40 are end-face sealingly connected through the end face of the first sealing member 42 to block the waterway between the water inlet 40b and the second water outlet 40d, communicate the waterway between the water inlet 40b and the first water outlet 40c.

At this time, with reference to FIG. 1, the cleaning device is in the roller brush working mode or the shutdown mode. When in the roller brush cleaning mode, the main base water pump works, and the clean water in the upstream side channel 10 of the main water supply channel is sent into the valve cavity 40a through the water inlet 40b, and then sequentially enters the downstream side channel 11 of the main water supply channel through the first water outlet 40c and the roller brush water supply channel, and is finally sprayed from the nozzle 23 to the roller brush 22.

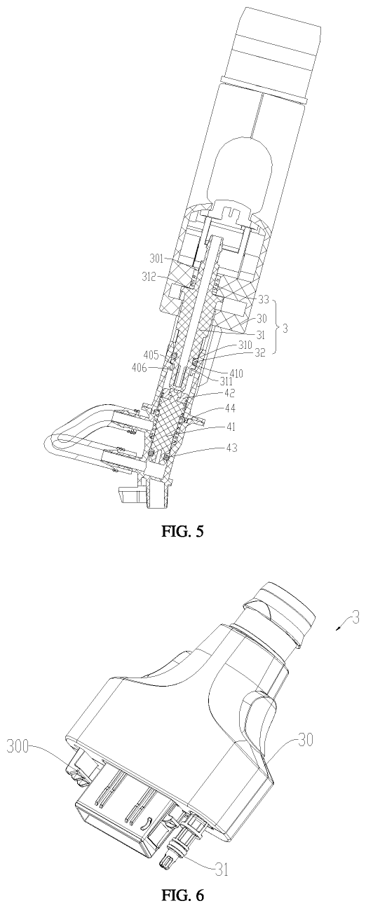

Referring to FIG. 5, when the piston rod 41 is subjected to an external force and moves to the second position against the elastic force of the first elastic apparatus 44, the valve body 40 and the piston rod 41 are radially sealed by the second sealing member 43, blocking the waterway between the water inlet 40b and the first water outlet 40c; and the first sealing member 42 moves with the piston rod 41 to release the end seal connection between the valve body 40 and the piston rod 41, thereby allowing the water inlet 40b and the second water outlet 40d to communicate through the valve cavity 40a, that is, the waterway between the water inlet 40b and the second water outlet 40d is communicated.

In this embodiment, the accessory brush assembly 3 is used to push the piston rod 41 to move linearly between the first position and the second position in the valve cavity 40a.

Specifically, continuing to refer to FIG. 5, the accessory brush assembly 3 of the cleaning device is detachably connected to the body 1. The accessory brush assembly 3 includes a water inlet pipe connector 31. The water inlet pipe connector 31 is configured to insert into the valve cavity 40a and push the piston rod 41 to move between the first position and the second position. In order to facilitate understanding of the structure of the accessory brush assembly 3, please refer to FIG. 6 as well.

After the water inlet pipe connector 31 is inserted into the valve cavity 40a, it will push the piston rod 41 to move from the first position to the second position under the action of external force. At the same time, the second sealing member 43 is gradually pressed between the piston rod 41 and the walls of the valve cavity 40a until reaching the second position to form the radial seal, thereby blocking the passage between the water inlet 40b and the first water outlet 40c.

The first sealing member 42 gradually moves away from the first flange 406, and the water inlet pipe connector 31 is inserted into the valve cavity 40a through the second water outlet 40d to communicate the passage between the water inlet 40b and the second water outlet 40d, that is, the water inlet 40b and the water inlet pipe connector 31 are communicated through the valve cavity 40a. The clean water from the clean water bucket of the cleaning device enters the valve cavity 40a through the water inlet 40b, and is finally transported to the accessory brush assembly 3 through the water inlet pipe connector 31.

Specifically, when the water inlet pipe connector 31 is inserted into the valve cavity 40a through the second water outlet 40d, the water inlet pipe connector 31 pushes the piston rod 41 to move from the first position to the second position, and the end face seal between the piston rod 41 and the valve body 40 is released, and after starting the main base water pump, the clean water in the upstream side channel enters the valve cavity 40a through the water inlet 40b, and then enters part of the valve cavity above the first sealing member 42 from gaps between the two of the piston rod 41 and the first sealing member 42 and the inner wall of the valve cavity. The water inlet pipe connector 31 is provided with a radial through hole, and the water in the partial valve cavity enters the water inlet pipe connector 31 through the radial through hole.

It can be seen that before the accessory brush assembly 3 is assembled, the second waterway of the changeover valve assembly 4 is constituted by the water inlet 40b, the piston rod 41 and the inner wall of the valve cavity, the first sealing member 42 and the inner wall of the valve cavity, and the second water outlet 40d.

In this embodiment, the water inlet pipe connector 31 is directly inserted into the valve cavity 40 through the second water outlet 40d, and the valve cavity 40 is directly introduced into the water inlet pipe connector 31.

In other embodiments, the water inlet pipe connector 31 can also abut with the second water outlet 40d through welding way or other auxiliary structures, so that the water in the valve cavity 40 flows into the water inlet pipe connector 31 through the second water outlet 40d.

In order to prevent water leakage in the fitting gap between the water inlet pipe connector 31 and the valve cavity 40a, referring to FIG. 5, in this embodiment, a third sealing member 32 is provided on the water inlet pipe connector 31, and the third sealing member 32 is configured to form a radial seal between the water inlet pipe connector 31 and the inner wall of the valve cavity 40a.

Specifically, the water inlet pipe connector 31 has a second circumferential sealing ring groove 310, and the third sealing member 32 is an O-ring. The third sealing member 32 is installed in the second circumferential sealing ring groove 310. When the water inlet pipe connector 31 is inserted into the valve cavity 40a of the valve body 40, the third sealing member 32 is filled between the inner wall of the valve cavity 40a and the water inlet pipe connector 31 to play a sealing role.

In addition, in order to limit the stroke of the piston rod 41 in the valve cavity 40a, when the piston rod 41 moves from the first position to the second position in the valve cavity 40a, the water inlet pipe connector 31 and the valve body 40 cooperate through a limiting mechanism.

Specifically, the limiting mechanism includes a third axial limit ring surface 311 and a fourth axial limit ring surface 405 offset each other, and the third axial limit ring surface 311 and a fourth axial limit ring surface 405 are matching. More specifically, the third axial limit ring surface 311 is arranged on the water inlet pipe connector 31, and the fourth axial limit ring surface 405 is arranged on the inner wall of the valve cavity 40a.

Continuing to refer to FIG. 5, the accessory brush assembly 3 also includes a base 30 and a second elastic apparatus 33; the base 30 is configured for the body 1 or the roller brush assembly to be detachably connected together, and the second elastic apparatus 33 is located between the water inlet pipe connector 31 and the base 30, the water inlet pipe connector 31 is configured to move along the insertion direction of the valve body 40 under the elastic force of the second elastic apparatus 33.

The second elastic apparatus 33 can be specifically a compression spring, which is sleeved on the water inlet pipe connector 31 and is pre-pressed between the fifth axial limit ring surface 301 and the sixth axial limit ring surface 312.

Specifically, the base 30 has a channel for communicating with the water supply channel of the accessory brush assembly 3. A part of the water inlet pipe connector 31 extends into and is installed in said channel in an axially movable manner. Said water inlet pipe connector 31 communicates an external water pipe through a part of the water supply pipe arranged on the base, or directly communicates an external water pipe through the water inlet pipe connector 31, to deliver clean water to the brush head and other components of the accessory brush assembly. The fifth axial limit ring surface 301 is formed by extending radially inwardly from the inner wall of the channel of the base 30, and the sixth axial limit ring surface 312 is formed by extending outwardly from the outer peripheral wall of the water inlet pipe connector 31.

Specifically, the elastic force of the second elastic apparatus 33 is greater than the elastic force of the first elastic apparatus 44, the arrangement of which may avoid the piston rod 41 moving from the direction of the first position under the elastic force of the first elastic apparatus 44 causing the failure of the working mode of the cleaning device.

In addition, the elastic force of the second elastic apparatus 33 is greater than the elastic force of the first elastic apparatus 44, which effectively solves the problem of unstable insertion depth of the water inlet pipe connector 31 due to injection molding tolerances and assembly tolerances of each part, resulting in leakage of the accessory brush.

The roller brush cover 20 is provided with an accessory waterway installation port 203 for the water inlet pipe connector 31 to pass through and extend into the valve cavity 40a of the valve body 40.

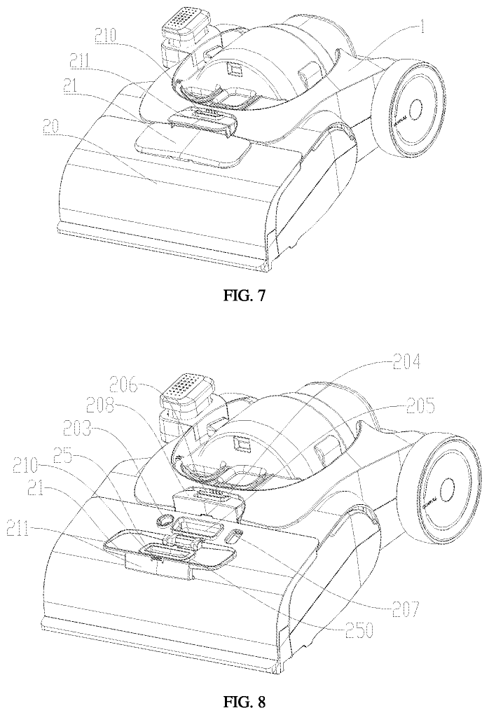

With reference to FIGS. 6 and 7, the base 30 of the accessory brush assembly 3 and the roller brush cover 20 are detachably connected by a first elastic hook 300 and a first slot (not shown in the drawings) which are matching with each other. Said first elastic hook 300 is arranged on the accessory brush assembly 3, and the first slot is arranged on the roller brush cover 20.

When assembling the base 30 of the accessory brush assembly 3 and the roller brush cover 20, the water inlet pipe connector 31 is firstly inserted into the valve cavity 40a through the accessory waterway installation port 203, and the base 30 is pressed to cause the first elastic hook 300 to elastically deform to be stuck into the first slot and is clamped tightly in the first slot under the action of its own elastic force. The base 30 can be removed from the body 1 by reverse operation.

In other embodiments, the first elastic hook 300 and the first slot can also be arranged oppositely, that is, the first elastic hook 300 is arranged on the body 1 and the first slot is arranged on the accessory brush assembly 3.

With reference to FIGS. 8 to 10, the cleaning device also has a sewage suction channel, which is configured to suck dust, debris, sewage, etc. on the working surface into the sewage tank.

The main body 1 of the cleaning device is provided with a main sewage suction channel 12 communicating the sewage tank. The roller brush cover 20 is provided with a roller brush sewage suction channel 20b. The roller brush sewage suction channel 20b communicates the main sewage suction channel 12. The sewage suction port of the sewage suction channel 20b faces the working surface in front of the roller brush 22.

Referring to FIG. 8, the body 1 is also provided with a valve body through hole 13 for the valve body 40 of the changeover valve assembly 4 to pass through. After the body 1 and the changeover valve assembly 4 are assembled, the valve body 40 extends through the valve body through hole 13 to the outside of the body to facilitate docking with the accessory brush assembly 3.

Referring to FIG. 1 and FIG. 10, the roller brush sewage suction channel 20b is enclosed between the second layer plate 201 and the third layer plate 202 of the roller brush cover 20. The main sewage suction channel 12 and the roller brush sewage suction channel 20b are end-face sealed through a fourth sealing member 24. After the roller brush cover 20 and the body 1 are connected in a fixed or detachable manner, the third sealing member 24 is pressed against an end surface where the main sewage suction channel 12 and the roller brush suction channel 20b are facing each other.

Specifically, the roller brush sewage suction channel 20b extends obliquely from the upper end of the roller brush cover 20 to the lower end of the roller brush cover 20. The roller brush sewage suction channel 20b includes a straight pipe section and an inclined section communicating the straight pipe section. The straight pipe section of the roller brush sewage suction channel 20b cooperates with the end surface of the first sealing member 24 located at the main sewage suction channel 12 to form an end face seal.

When the main motor of the cleaning device is working, a negative pressure chamber is formed in the sewage tank. Under the action of the internal and external pressure difference, dust and/or debris on the working surface are sucked into the sewage tank through the roller brush sewage suction channel 20b and the main sewage suction channel 12 in turn.

The accessory brush assembly 3 also includes a suction pipe joint 34, which is configured to communicate with the main sewage suction channel 12 and close the roller brush sewage suction channel 20b.

With reference to FIGS. 8 and 10, the roller brush cover 20 is also provided with an accessory suction port 205. The suction pipe joint 34 is inserted into the straight pipe section of the roller brush sewage suction channel 20b through the accessory suction port 205 and communicates with the main sewage suction channel 12. The suction pipe joint 34 penetrates into the fourth sealing member 24 and forms a radial seal with the side wall of the fourth sealing member 24, thus communicating the suction pipe joint 34 and the main sewage suction channel 12 and blocking the roller brush sewage suction channel 20b and the main sewage suction channel 12. The cleaning device has independent dedicated sewage suction channels in different working modes, and the main sewage suction channels 12 are reused in the two different working modes, making the overall structure of the cleaning device compact and simple.

Of course, in other embodiments, the cleaning device can be configured with completely independent sewage suction channels for the roller brush assembly and the accessory brush assembly 3. These independent sewage suction channels can share one sewage tank, or each can be equipped with an independent sewage tank.

With reference to FIGS. 7 to 9, in order to prevent dirt from being ejected from the accessory sewage suction port 205 on the roller brush cover 20, when the cleaning device is in the roller brush working mode, in this embodiment, the roller brush assembly also includes a cover plate 21. The cover plate 21 is detachably connected to the roller brush cover 20 and is configured to block the accessory sewage suction port 205 on the roller brush cover 20 and the accessory waterway installation port 203.

The assembly of the accessory brush assembly and the disassembly and assembly of the cover plate can reuse part of the structure, making the structure compact.

Specifically, the body 1 has a notch, and the side wall of the notch provided with a second slot 14. The roller brush cover 20 extends outward to form a positioning block 208 that matches said notch. The positioning block 208 is provided with a buckle block 206 in a movable manner, and the buckle block 208 is provided with a second hook (not shown in the drawings) that matches the second slot 14. Said roller brush cover 20 also includes a third elastic apparatus (not shown in the drawings) that is pre-pressed between the body 1 and the buckle block 208, and under the elastic force of the third elastic apparatus, the second hook and the second slot 14 buckle together.

When receiving an external force, the buckle block 208 moves against the elastic force of the third elastic apparatus to drive the second hook to move until disengage from the second slot.

When the roller brush cover 20 is assembled with the machine body 1, the positioning block 208 is inserted into the notch on the machine body 1, and the buckle block 206 is pressed so that the second hook is inserted into the second slot 14. After the external force is removed, under the action of the third elastic force of the third elastic apparatus, the second hook and the second slot 14 remain in the engaged state.

When it is necessary to remove the roller brush cover 20 from the machine body 1, the buckle block 206 is pressed again, and the buckle block 206 overcomes the elastic force of the third elastic apparatus under the action of external force and moves to disengage the second hook and the second slot, and then the roller brush cover 20 is removed.

The cover plate 21 and the roller brush cover 20 are detachably connected through a matching third elastic hook 210 and a corresponding third slot 204, wherein the third elastic hook 210 is arranged on the cover plate 21, and the third slot is arranged on the positioning block 208 of the roller brush cover 20. In addition, in order to facilitate operation, the cover plate 21 is also provided with a handle 211. The handle 211 is specifically an L-shaped structure, which includes a connecting part and a hand-held part. The hand-held part is basically parallel to the surface of the cover and an operating space is presented therebetween for allowing finger-holding or tool assisting.

Moreover, the cover plate 21 and the roller brush cover 20 are hinged through a hinge shaft, facilitating which to rotate relative to the roller brush 20 to seal the sewage suction port 205 and the accessory waterway installation port 203, or to open the sewage suction port 205 and the accessory waterway installation port 203. In addition, the cover plate 21 is always connected to the roller brush cover 20, which can prevent the cover plate 21 from being lost.

Besides, when it is necessary to remove the roller brush cover 20, the handle 211 is used as one of the focusing points, and the thumb presses the buckle block 206 of the roller brush cover 20, so that the second hook comes out of the second slot 14, and then the roller brush cover 20 can be removed. During this process, the user has two focusing points, making the roller brush cover 20 to be removed from the body 1 easily.

Further, the cover plate 21 is provided with a fifth sealing member 25 that matches the shape of the swage suction port 205 of the accessory brush. The cover plate 21 blocks the accessory brush sewage suction 205 on the roller brush cover 20 through the fifth sealing member 25.

In order to further enhance the blocking effect of the accessory brush sewage suction port 205, in this embodiment, the sealing member and the roller brush cover 20 are positioned and connected through a positioning groove 250 and a positioning boss 207 matching each other. Specifically, the positioning boss 207 is arranged on the roller brush cover 20 and surrounds the accessory sewage suction port 205, and the positioning groove 250 is arranged on the fifth sealing member 25.

### Embodiment 2

Compared with Embodiment 1, the main difference between Embodiment 2 and Embodiment 2 lies in the sealing method between the piston rod 41 and the valve cavity 40a in the first position. In order to facilitate understanding and keep the text concise, this article will illustrate the differences with the help of drawings, and the same parts will not be repeated again.

In addition, in order to more clearly display the differences between the two embodiments, for components with the same functions, the component names, that is, reference signs in the first embodiment are used in the second embodiment.

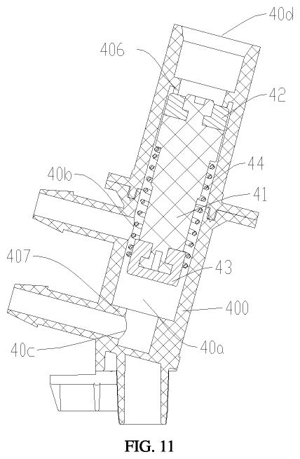

With reference to FIGS. 10 and 11, in this embodiment, the second sealing member 43 is arranged at the other end of the piston rod 41. Referring to the view direction of FIG. 10, the second sealing member 43 is arranged at the lower end of the piston rod 41. The inner wall of the valve cavity 40a is provided with one ring of a second flange 407 extending radially inward at a position located between the water inlet 40b and the first water outlet 40c; and the second sealing member 43 is configured to contact and seal with an end face of the second flange 407.

In detail, the second sealing member 43 covers one end of the piston rod 41, that is, the second sealing member 43 covers one end surface and part of the outer peripheral wall of the piston rod 41.

When the water inlet pipe joint of the accessory brush assembly 3 is inserted into the valve cavity 40a to push the piston rod 41 to move to the second position, the second sealing member 43 and the second flange 407 protrudingly provided on the inner wall of the valve cavity 40a of the valve body 40 abut, and is compressed and deformed under the action of the second elastic apparatus 33, thereby forming an end-face sealing connection between the piston rod 41 and the valve body 40. In addition, along the axial direction, the water inlet 40b and the first water outlet 40c are respectively arranged on two sides of the second flange 407.

When in the first working position, the piston rod 41 and the valve body 40 achieve end face sealing through the second sealing member 43, which reduces the movement resistance during operation of the piston rod and reduces the reliability of spring force recovery due to large movement resistance and life issues, avoiding the risk of failure due to piston rod being stuck, while reducing the user's assembly and insertion force, and improving convenience.

Based on the end-face sealing connection relationship between the piston rod 41 and the valve body 40, in this embodiment, the first elastic apparatus 44 is pre-pressed between the second axial limit ring surface 412 of the piston rod 41 and the second flange 407.

Of course, the installation method of the first elastic apparatus 44 is not limited to this.

In other embodiments, another flange extending radially inward can also be provided on the inner wall of the valve cavity between the water inlet 40b and the first water outlet 40c. Said flange is configured to cooperate with the second axial limit ring surface 412 of the piston rod 41 to position the first elastic apparatus 44 between the valve body 40 and the piston rod 31, and is located between the water inlet 40b and the first water outlet 40c.

When the piston rod 41 is in the first position, the main base water pump is started, and clean water sequentially enters the gap between the inner wall of the valve cavity, the piston rod 41 and the second sealing member 43, part of the valve cavity between the second sealing member 44 and the first water outlet 40c from the water inlet 40b, and finally flows out from the first water outlet 40c.

After the piston rod 41 is moved from the first position to the second position by an external force, the piston rod 41 and the valve body 40 are end face sealed through the second sealing member 43, and the first waterway of the valve body 40 is disconnected. However, the end face sealing connection relationship between the piston rod 41 and the valve body 40 formed by the first sealing member 42 is released, and the second waterway of the valve body 41 is communicated.

Start the main base water pump, clean water will sequentially enter the gap between the inner wall of the valve cavity, the piston rod 41 and the first sealing member 42, part of the valve cavity between the first sealing member 42 and the second water outlet 40d from the water inlet 40b, and finally flows out from the second water outlet 40d.

Of course, the connection method between the second waterway and other components such as the accessory brush assembly 3 is the same as in the first embodiment, that is, the water inlet pipe connector 31 is inserted into the valve cavity 40 through the second water outlet 40d and then directly connected to the valve cavity 40, or the water inlet pipe connector 31 is connected to the second water outlet 40d and then communicates with the valve cavity 40.

### Application Scenarios:

The cleaning device provided by the present disclosure can be, for example, a carpet washer (cleaning machine). When the user needs to clean the carpet at home, the piston rod of the changeover valve assembly is in the first position. At this time, the cleaning liquid in the clean water tank enters the valve cavity through the water inlet, and communicated to the position of the roller brush through the first water outlet. Turn on the water pump and roller brush motor of the cleaning machine. The cleaning fluid in the clean water tank is sprayed on the roller brush through the corresponding pipe. The carpet is scrubbed under the rotation of the roller brush. The sewage generated after the scrubbing can be sucked into the sewage tank of the cleaning device through the roller brush sewage suction channel.

When the user needs to clean other locations with a certain height or limited space, such as cleaning the sofa surface, the accessory brush assembly can be inserted into the cleaning device. Specifically, the user opens the cover plate to expose the accessory waterway installation port, the water inlet pipe connector is inserted into the second water outlet position of the valve cavity through the accessory waterway installation port, and pushes the piston rod to move from the first position to the second position. At this time, the first waterway from the water inlet to the first water outlet of the changeover valve assembly is blocked, and the cleaning fluid in the clean water tank enters the accessory brush through the water inlet, the second water outlet, and the water inlet pipe connector. Thereby, the cleaning fluid of the cleaning device is supplied to the accessory brush assembly, and the user can clean the sofa surface by holding the accessory brush assembly.

In addition, the suction pipe joint in the accessory brush assembly can be inserted into the straight pipe section of the roller brush sewage suction channel through the sewage suction port, and is sealingly connected with the main sewage suction channel, thus blocking the communicating between the main sewage suction channel and the roller brush sewage suction channel. At this time, open the cleaning device, and the sewage after cleaning by accessory brush assembly can be sucked into the sewage tank of the cleaning device.

As shown in FIG. 13, an embodiment of the present disclosure provides a cleaning apparatus 13100. The cleaning apparatus 13100 includes a main body 1310, a sewage bucket 1320 and a vacuum motor 1330, which can improve sewage recovery efficiency and reduce sewage residue in the area being cleaned. The cleaning apparatus described here can be configured as a corresponding form of cleaning device to complete different cleaning functions according to the functional requirements of different application scenarios, which is not limited in the embodiments of the present disclosure. Specifically, the X direction, Y direction and Z direction can be defined as follows. The X direction is the forward direction of the main body 1310, the Y direction is the width direction of the main body 1310, the X direction and the Y direction are orthogonal directions in the horizontal plane, and the Z direction is the vertical extension direction of the main body 1310.

The main body 1310 is provided with a suction port 1311 and a fluid channel 1312. The suction port 1311, the fluid channel 1312 and the air inlet end of the sewage bucket 1320 are connected in sequence, and the air outlet end 1321 of the sewage bucket 1320 and the air inlet end 1331 of the vacuum motor 1330 are adjacent and are connected. Further, the air outlet end 1321 of the sewage bucket 1320 and the air inlet end 1331 of the vacuum motor 1330 are directly connected. In this way, the suction port 1311, the fluid channel 1312, the sewage bucket 1320 and the air inlet end 1331 of the vacuum motor 1330 can be communicated in sequence. The vacuum motor 1330 can form a negative pressure at the suction port 1311, so that the air on the surface of the area to be cleaned and the sewage are sucked from the suction port 1311 under the negative pressure, and enter the sewage bucket 1320 through the fluid channel 1312. The sewage bucket 1320 can separate the air and the sewage, so that the sewage is retained in the sewage bucket 1320 and the air passes through the outlet of the sewage bucket 1320 and the air inlet end 1331 of the vacuum motor 1330, and is discharged into the vacuum motor 1330 to realize the sewage suction process.

In the related art, the air inlet end 1331 of the vacuum motor 1330 of the cleaning machine and the air outlet end 1321 of the sewage bucket 1320 need to be connected through a long hose, and the hose is prone to bending. In this way, the air flow of the vacuum motor 1330 and the sewage bucket 1320 has a large pipeline resistance, which is prone to poor air flow and even blockage. Correspondingly, the vacuum motor 1330 cannot guarantee the required negative pressure of the suction port 1311, so that the suction power of the suction port 1311 is insufficient and the sewage suction flow rate of the suction port 1311 decreases. Since the cleaning machine needs to recycle sewage during movement, the low sewage suction flow rate of the suction port 1311 may easily result in the sewage not being recycled in time, causing more sewage residues on the floor or carpet.

In the cleaning apparatus 13100 provided by the embodiment of the present disclosure, since the air inlet end 1331 of the vacuum motor 1330 and the air outlet end 1321 of the sewage bucket 1320 can be arranged adjacently and connected to each other or directly connected, there is no need to connect the air inlet end 1331 and the air outlet end 1321 with a pipeline, or only need a relative short pipeline to connect the two, which can make the air flow between the sewage bucket 1320 and the vacuum motor 1330 smoother, avoid poor air intake caused by the bending layout of the pipeline, and ensure a sufficient pressure difference between the suction port 1311 and the external air environment, and the suction port 1311 has a high sewage suction flow rate; in this way, the suction port 1311 can promptly recycle sewage during the movement of the cleaning apparatus 13100, the sewage recovery efficiency is improved, and the sewage residue in the area being cleaned is reduced.

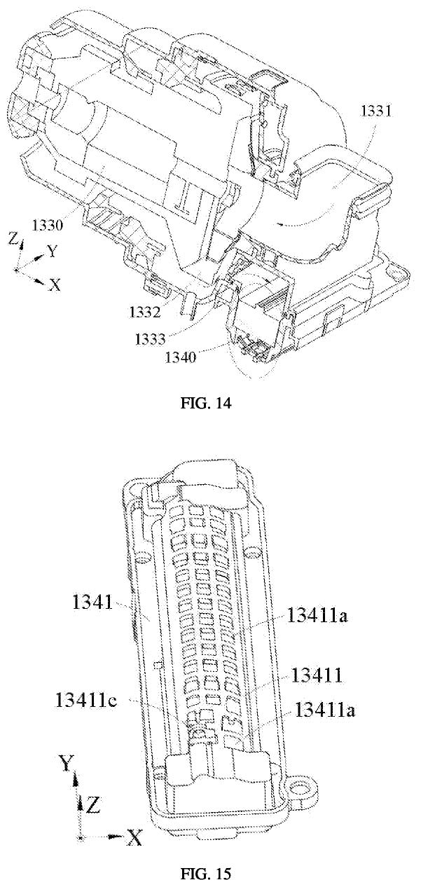

As shown in FIGS. 13-14, in some embodiments, the axial direction of the vacuum motor 1330 can be parallel to the forward direction of the main body 1310, and the air inlet end 1331 of the vacuum motor 1330 is arranged on one side of the vacuum motor 1330 in the forward direction, the air inlet end 1331 opens upward, and can be directly connected to the air outlet end 1321 of the sewage bucket 1320, that is, the air inlet end 1331 of the vacuum motor 1330 is arranged below the air outlet end 1321. The air inlet end 1331 of the vacuum motor 1330 descried here can have an elbow structure to directly connect with the air outlet end 1321 of the sewage bucket 1320. The elbow structure of the air inlet end 1331 connects the axial air inlet of the vacuum motor 1330 and the air outlet end 1321 of the sewage bucket 1320. The axial air inlet of the vacuum motor 1330 is provided on one side of the vacuum motor 1330 along its axial direction toward the forward direction. In another embodiment, an elbow structure can also be provided at the air outlet end 1321 of the sewage bucket 1320 to directly connect with the axial air inlet of the vacuum motor 1330. Compared with the arrangement in the related art in which the axial direction of the vacuum motor is perpendicular to the forward direction of the main body, the above arrangement can shorten the distance between the air outlet end 1321 of the sewage bucket 1320 and the axial air inlet of the vacuum motor 1330. Moreover, the air outlet end 1321 is directly connected to the air inlet end 1331, which avoids complicated pipeline directions and reduces the loss of suction air pressure, thereby improving the sewage recovery rate. In addition, the sewage bucket 1320 can be arranged above the vacuum motor 1330 to improve space utilization efficiency on the main body 1310.

In some examples, the suction port 1311 can be arranged at the front area of the main body 1310 along its forward direction, and the air inlet end 1331 of the vacuum motor 1330 can be arranged at the front end of the vacuum motor 1330 along the forward direction of the main body 1310. In other examples, the suction port 1311 can be arranged at the rear area of the main body 1310 along its forward direction, and the air inlet end 1331 of the vacuum motor 1330 can be arranged at the rear end of the vacuum motor 1330 along the forward direction of the main body 1310. On the one hand, the above arrangement can make the air inlet end 1331 of the vacuum motor 1330 closer to the suction port 1311, shorten the distance between the air inlet end 1331 of the vacuum motor 1330 and the suction port 1311, and ensure the vacuum motor providing a sufficient pressure difference between the suction port 1311 and the environments, so that the suction port 1311 has a high suction flow rate; on the other hand, compared with the arrangement in the related art in which the axial direction of the vacuum motor is perpendicular to the forward direction of the main body, the above arrangement may make fully used of the structural layout on the main body 1310 along the forward direction, reducing the space occupation on the opposite sides of the main body 1310 along its width direction can be reduced. The width size of the main body 1310 or the height size of opposite sides along the width direction can be compressed, which improves the passing ability of the main body 1310 in different environments.

As shown in FIGS. 13 to 17, in some embodiments, the cleaning apparatus 13100 may also include a heating air outlet assembly 1340. The heating air outlet assembly 1340 may include an air outlet casing 1341 and a heater 1342 arranged on the air outlet casing 1341. One side of the air outlet casing 1341 is connected to the air outlet 1332 of the vacuum motor 1330, and the other side forms an air outlet portion 13411. The heater 1342 may be arranged between the air outlet 1332 of the vacuum motor 1330 and the air outlet portion 13411.

After the air is discharged into the vacuum motor 1330 through the air outlet 1321 of the sewage bucket 1320 and the air inlet end 1331 of the vacuum motor 1330, it can further enter the air outlet casing 1341 through the air outlet 1332 of the vacuum motor 1330. The heater 1342 on the air outlet casing 1341 is capable of generating heat to heat the air to form hot air. The hot air is blown to the surface of the area to be cleaned through the air outlet portion 13411 of the air outlet casing 1341, prompting the moisture on the surface of the area to be cleaned to evaporate at an accelerated rate. The cleaned area can be dried quickly to avoid the growth of bacteria and odor caused by long-term moisture residue.

In some examples, an air outlet 1332 may be formed on the outer peripheral surface of one end of the vacuum motor 1330 close to the air inlet end 1331, and an air outlet hood 1333 may be provided at the air outlet 1332. The air outlet hood 1333 is connected to the air outlet casing 1341. The air outlet hood 1333 can discharge air toward the bottom of the main body 1310 along the height direction of the main body 1310, and guide the circumferential air outlet of the air outlet 1332 vertically downward to the heating air outlet assembly 1340. The orthographic projection of the air outlet surface of the air outlet hood 1333 on the plane where the air outlet casing 1341 is located can cover the air outlet casing 1341, ensuring a large air exchange area between the air outlet hood 1333 and the air outlet casing 1341. Alternatively, the orthographic projection of the air outlet surface of the air outlet hood 1333 on the plane where the air outlet casing 1341 is located covers the heater 1342, so that the air outlet from the main motor can flow through the heater 1342 on the complete cross section of the heater 1342.

The installation position of the heating air outlet assembly 1340 described here can be determined according to actual needs, and this is not limited in the embodiment of the present disclosure. In some examples, the air outlet portion 13411 of the heating air outlet assembly 1340 is located on one side of the main body 1310 facing the area to be cleaned, that is, at the bottom of the main body 1310. In this way, the air outlet portion 13411 can be located between the main body 1310 and the area to be cleaned, the hot air is blown quickly and directly to the area to be cleaned, so that the area to be cleaned can be dried quickly. In some examples, the main body 1310 may be provided with a roller brush installation portion 1313, and the roller brush 1350 may be arranged on the roller brush installation portion 1313. The roller brush 1350 described here can use various roller-type brush bodies suitable for rotation according to the application requirements of the cleaning apparatus 13100 to scrub the surface of the area to be cleaned such as the floor or carpet.

Correspondingly., along the forward direction, the air outlet portion 13411 of the heating air outlet assembly 1340 is located behind the roller brush installation portion 1313, so that the air outlet portion 13411 of the heating air outlet assembly 1340 directly dries the area scrubbed by the roller brush 1350. In addition, the air outlet portion 13411 of the heating air outlet assembly 1340 can be located between the motor 1330 and the roller brush to more conveniently utilize the air outlet of the motor 1330 for drying after cleaning in terms of structural arrangement. The air outlet portion 13411 of the heating air outlet assembly 1340 described here can be deflected in a direction away from the roller brush installation portion 1313. On the one hand, the amount of hot air blown in the air outlet portion 13411 to the roller brush 1350 can be reduced, and the roller brush 1350 can be prevented from being overheated which may introduce structural deformation and lifespan loss, on the other hand, can allow most of the hot air in the air outlet portion 13411 to be blown relatively directly to the area scrubbed by the roller brush 1350, thereby increasing the drying rate.

In a preferred embodiment, referring to FIGS. 13 and 14, the projections of the air inlet end 1331 of the motor 1330 and the heating air outlet assembly 1340 at least partially coincide on the horizontal plane, or the axis of the air inlet end 1331 of the motor 1330 coincides with the axis of the heating air outlet assembly 1340. The axis direction is perpendicular to the horizontal plane. In this way, the structure of the motor 1330, the sewage bucket 1320, and the heating air outlet assembly 1340 is more compact, and the arrangement of each component is more reasonable and efficient. That is to say, the projections of the air outlet end 1321 of the sewage bucket 1320 and the heating air outlet assembly 1340 at least partially coincide on the horizontal plane, or the axis of the air outlet end 1321 of the sewage bucket 1320 coincides with the axis of the heating air outlet assembly 1340. In another embodiment, the length of a projection on the horizontal plane of the bending tube connecting the axial air inlet of the motor 1330 and the air inlet end 1331 of the motor 1330 is equal to the length of the air outlet end 1321 of the sewage bucket. In this way, the arrangement of the sewage bucket and the motor is compacted to the utmost extent.

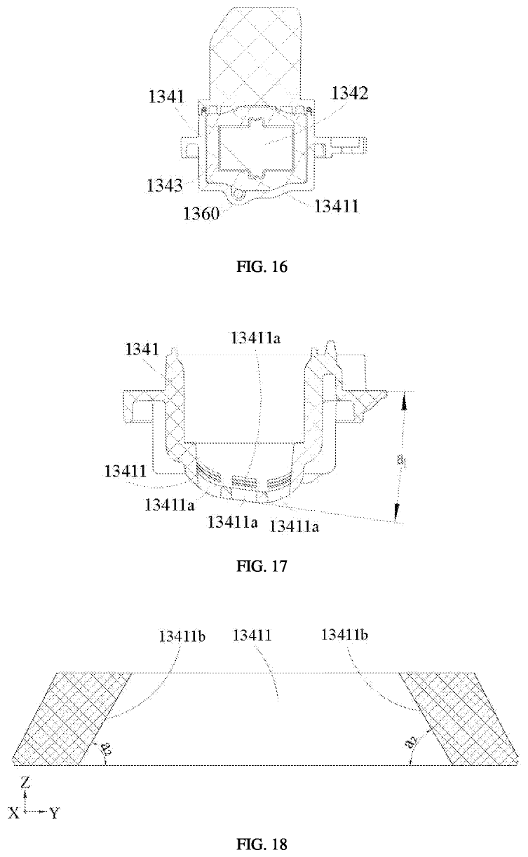

As shown in FIG. 17, the orthographic projection of the air outlet portion 13411 of the heating air outlet assembly 1340 on the first plane can be called the first projection. The first plane is parallel to the forward direction of the main body 1310 and perpendicular to extension direction of the roller brush installation portion 1313; when the roller brush 1350 is installed on the roller brush installation portion 1313, the axial direction of the roller brush 1350 is consistent with the extension direction of the roller brush installation portion 1313. Correspondingly, the first plane is also perpendicular to the axis direction of the roller brush 1350. In some examples, the included angle a1 between the top of the first projection or the tangent line of the top and the forward direction of the main body 1310 (hereinafter referred to as the first included angle) may be set to 5° to 20°, for example, 5°, 5.5°, 6°, 6.4°, 6.70, 7°, 7.30, 7.5°, 8°, 8.2°, 8.6°, 9°, 9.5°, 10°, 10.5°, 11°, 11.5°, 12°, 12.5°, 13°, 13.5°, 14°, 14.5°, 15°, 15.5°, 16°, 16.5°, 17°, 17.5°, 18°, 18.5°, 19°, 19.5° or 20°, etc. Within this angle range, on the one hand, the air outlet portion 13411 can have a sufficient deflection angle relative to the roller brush installation portion 1313, and the amount of hot air blown to the roller brush 1350 in the air outlet portion 13411 is small, the heat loss subjected by the roller brush 1350 can be better lowered, on the other hand, make the main area of the air outlet portion 13411 facing the area scrubbed by the roller brush 1350, and most of the hot air in the air outlet portion 13411 can be blown relatively directly to the area scrubbed by the roller brush 1350, to avoid insufficient hot air volume blown to the area scrubbed by the roller brush 1350 due to excessive deflection angle, and to reduce the loss of hot air and drying heat energy. For example, the first included angle may be 7° to 10°, so that the above effect is more significant. Preferably, the first included angle is 8°.

The shape of the first projection is different according to the shape of the air outlet portion 13411; accordingly, the first included angle may be the included angle between the top of the first projection and the forward direction of the main body 1310, or the angle between the tangent line of the top of the first projection and the forward direction of the main body 1310. For example, the first projection may have an arc-shaped structure, and the first included angle is the angle between the tangent line of the arc-shaped structure at its top and the forward direction of the main body 1310. As another example, the first projection may include a first arc segment, a straight line segment and a second arc segment that are smoothly connected in sequence. The top of the first projection is located on the straight segment, then the first included angle is the included angle between the straight line segment and the forward direction of the main body 1310.

In some examples, the air outlet portion 13411 of the heating air outlet assembly 1340 may have a long strip structure, and the extension direction of the air outlet portion 13411 is the length direction. The length direction of the air outlet portion 13411 can be parallel to the extension direction of the roller brush installation portion 1313, so that the air outlet portion 13411 can better match the axial size of the roller brush 1350 and increase the coverage area of the area after scrubbed by the roller brush 1350 along the axial direction of the roller brush 1350, and improve the drying efficiency.

As shown in FIG. 18, in some examples, the air outlet portion 13411 has two side walls 13411b arranged oppositely along the width direction of the main body 1310, wherein at least one side wall 13411b is configured to guide air along a direction away from the other side wall 13411b. The width direction of the main body 1310 is perpendicular to the forward direction of the main body 1310. For example, in the two side walls 13411b of the air outlet portion 13411 that are oppositely arranged along the width direction of the main body 1310, only one side wall 13411b is configured to discharge air in a direction away from the other side wall 13411b, while the other side wall 13411b is not configured in this way. As another example, FIG. 6 is the projections of the two side walls 13411b on the YZ plane. In the two side walls 13411b of the air outlet portion 13411 that are oppositely arranged along the width direction of the main body 1310, any side wall 13411b is configured to discharge air in a direction away from the other side wall 13411b.

In this way, near the side wall 13411b configured as above, the hot air can be blown in a direction away from the other side wall 13411b under the guidance of the side wall 13411b, thereby increasing the coverage area of the hot air along the width direction of the main body 1310 area, so that one or both sides of the area to be cleaned along the width direction of the main body 1310 can be dried by hot air, thereby improving drying efficiency and enhancing the drying effect. In addition, on the premise that the axial length of the roller brush 1350 remains unchanged, since the air supply range of the air outlet portion 13411 along the width direction of the main body 1310 is relatively large, the size of the air outlet 13411 in a width direction of the main body 1310 can be relatively reduced, to make the structure relatively compact and the material cost low.

The included angle between the extension direction of the side wall 13411b configured as above and the width direction of the main body 1310 can be called the air guide angle of the side wall 13411b; wherein, the extension direction of the side wall 13411b refers to a direction of one end of the side wall 13411b close to the heater 1342 pointing to the other end. The air guide angle can be determined according to actual needs, and is not limited in this embodiment of the disclosure. For example, the included angle a2 between the extension direction of the side wall 13411b configured as above and the width direction of the main body 1310 (hereinafter referred to as the second angle) is an acute angle, preferably, it can be 45° to 85°. °, for example, 45°, 48°, 51°, 55°, 57°, 60°, 62°, 65°, 70°, 75°, 80° or 85°, etc. Within this angle range, the side wall 13411b has a larger air supply angle along the width direction of the main body 1310, so that the air outlet portion 13411 has a larger hot air supply range.

For example, the angle a2 between the extension direction of at least one side wall 13411b and the width direction of the main body 1310 is 55˜65°. Within this angle range, in addition to the side wall 13411b having a larger air supply angle, the air outlet portion 13411 can also be made to have better structural strength and reliability, and thirdly the air outlet portion 13411 can be made easy for model shaping, manufacturing difficulty and cost can be reduced accordingly.

As shown in FIG. 15, in some examples, the air outlet portion 13411 may include a plurality of air outlet holes 13411a arranged in an array to increase the air outlet diversion effect of hot air and reduce outlet wind noise. The plurality of air outlets 13411a described here can be arrayed according to different array rules, and can adopt one or more methods such as a linear array, annular array, a square array, a circular array, etc., which is not limited in the embodiment of the present disclosure.

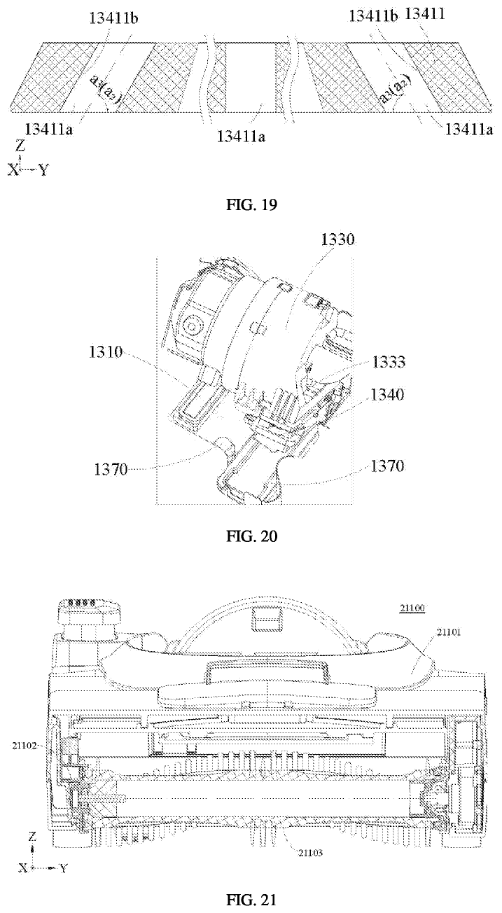

As shown in FIGS. 15 and 19, for example, the air outlet portion 13411 has two opposite ends along the width direction of the main body 1310, and the area between the opposite ends is the middle area of the air outlet portion 13411. At least one end of the air outlet portion 13411a is configured to discharge air in a direction away from the other end, and the air outlet portion 13411a in the middle area is configured to discharge air vertically downward; of course, the air outlet portion 13411 may not have the above-mentioned middle area. For example, in the opposite ends of the air outlet portion 13411 along the width direction of the main body 1310, only the air outlet hole 13411a at one end is configured to discharge air in a direction away from the other end, while the air outlet hole 13411a at the other end is not configured to do so. For another example, in the two opposite ends of the air outlet portion 13411 along the width direction of the main body 1310, the air outlet hole 13411a at either end is configured to discharge air in a direction away from the other end. At one end configured as above, there may be one or more air outlets 13411a configured to discharge air in a direction away from the other end. Specifically, the air outlet portion 13411 has a left end and a right end along the width direction of the main body 1310. The left end air outlet hole 13411a discharges air in a direction away from the right end, and the right end air outlet hole 13411a discharges air in a direction away from the left end. In this way, in the air outlet portion 13411a configured as above, hot air can be blown in a direction away from the other end, increasing the coverage area of the hot air along the width direction of the main body 1310, so that one side or two sides along the width direction of the main body 1310 located in the area to be cleaned can be subjected to the dry of the hot air, which improves drying efficiency and enhances drying effect. In addition, on the premise that the axial length of the roller brush 1350 remains unchanged, since the air supply range of the air outlet portion 13411 along the width direction of the main body 1310 is relatively large, the size of the air outlet portion 13411 along the width direction of the main body 1310 can be appropriately reduced, making the structure relatively compact and the material cost low. As configured above, at least one side wall 13411b in the two side walls 13411b that are oppositely arranged along the width direction of the main body 1310 is configured to guide air in a direction away from the other side wall 13411b. For example, an includes angle a3 between the air outlet direction of at least one end of the air outlet hole 13411a and the width direction of the main body 1310 is 45° to 85° (that is, the air outlet angle of the air outlet hole 13411a), such as 45°, 48°, 51°, 55°, 57°, 60°, 62°, 65°, 70°, 75°, 80° or 85°, etc. Within this angle range, the air outlet hole 13411a has a larger air supply angle along the width direction of the main body 1310, so that the air outlet portion 13411 has a larger hot air supply range. For example, for the air outlet portion 13411a located at the end along the width direction of the main body 1310, the second included angle a2 can be the included angle a3 between the air outlet direction of at least one end of the air outlet portion 13411a and the width direction of the main body 1310.

For example, the angle a3 between the air outlet direction of at least one end of the air outlet hole 13411a and the width direction of the main body 1310 is 55° ˜65°. Within this angle range, in addition to the air outlet portion 13411a having a larger air supply angle, the air outlet portion 13411 can be made to have better structural strength and reliability, and thirdly the air outlet portion 13411 can be made easy for model shaping, manufacturing difficulty and cost can be reduced accordingly.

For example, along the width direction of the main body 1310, a proportion of a sum of flow areas of the air outlet holes at one end of the air outlet portion arranged above in flow areas of the air outlet portion is a predetermined value, which can be decided according to actual needs, and the embodiment of the present disclosure does not limit this. Preferably, the predetermined value is not less than ¼ to ensure a sufficient air supply area, and the predetermined value is not greater than ½. For example, in the opposite ends of the air outlet portion 13411 along the width direction of the main body 1310, the air outlet hole 13411a at either end is configured to discharge air in a direction away from the other end; the proportion of a sum of flow areas of the air outlet holes at either end of the air outlet portion arranged above in flow areas of the air outlet portion is ⅓, and the proportion of a sum of flow areas of the air outlet holes at the middle area in flow areas of the air outlet portion is ⅓. For another example, the proportion of a sum of flow areas of the air outlet holes at either end of the air outlet portion arranged above in flow areas of the air outlet portion is ¼, and the proportion of a sum of flow areas of the air outlet holes at the middle area in flow areas of the air outlet portion is ½. For another example, when there is no middle area, the proportion of a sum of flow areas of the air outlet holes at either end of the air outlet portion arranged above in flow areas of the air outlet portion is ½, the air outlet portion 13411 located on the left to the right middle is one end air outlet hole, the air outlet portion 13411 located on the right to the right middle is the other end air outlet hole, and the flow areas of each of the two ends air outlet hole are ½.

For example, the air outlet angle a3 of the air outlet hole 13411a at one end is a first value, and the air outlet angle a3 of the air outlet hole 13411a at the other end is a second value. The first value and the second value may be equal or different, the first value may be a constant value and the second value may be a constant value as well, or one of the first vale and the second value may gradually decrease in a direction away from the other end. For example, at one end configured as above, the angle a3 between the air outlet direction of the air outlet hole 13411a and the width direction of the main body 1310 can gradually decrease in the direction away from the other end, so that the air outlet angle of the air outlet hole 13411a gradually increase in a direction close to the middle area of the air outlet portion 13411. For example, in the opposite ends of the air outlet portion 13411 along the width direction of the main body 1310, the air outlet hole 13411a at either end is configured to discharge air in a direction away from the other end; in the middle area of the air outlet portion 13411 along a width direction of the main body 1310, the included angle between the air outlet direction of the air outlet hole 13411a and the width direction of the main body 1310 may be 90°; the included angle a3 between the air outlet direction of the air outlet hole 13411a and the width direction of the main body 1310 may gradually decrease within the above-mentioned angle range from the middle area to any end of the opposite two ends.

For example, the air outlet hole 13411a that discharges air in a direction away from the other end of the air outlet portion 13411 can be formed in the following manner: the air outlet hole 13411a has two side walls parallel to the air outlet direction, and the two side walls are inclined, so that the air outlet direction of the air outlet hole 13411a is away from the other end of the air outlet portion 13411, that is, the angle between the two side walls and the width direction of the main body 1310 is the same as the air outlet angle of the air outlet hole 13411a.

The type of heater 1342 can be determined according to actual needs, and types such as heat pipe heaters, PTC (Positive Temperature Coefficient) heaters, etc. can be used, which are not limited in the embodiments of the present disclosure.

As shown in FIG. 16, in some examples, the heating air outlet assembly 1340 may further include a sealing member 1343 arranged between two end portions of the heater 1342 and the air outlet casing 1341. The sealing member 1343 described here may be a sealing ring with an annular structure. The sealing ring is sleeved on the outer peripheral side of the end of the heater 1342. The end surface of the sealing ring may be flush with the end surface of the heater 1342. In this way, the sealing ring can isolate the two ends of the heater 1342, so that the heater 1342 is tightly sealed, preventing external moisture from contacting the two ends of the heater 1342, and ensuring the electrical safety of the heater 1342. The type of sealing member 1343 can be determined according to actual needs, and can be of types such as sealing rings, sealing strips, sealants, etc., which are not limited in the embodiments of the present disclosure. For example, the sealing member 1343 can be made of soft colloid with an annular structure, and has the functions of waterproof sealing, heat insulation, buffering and shock absorption; the soft colloid described here can include rubber, soft plastic, silicone and other types.

For example, the heating air outlet assembly 1340 may also include a temperature sensor 1360. The inner side of the air outlet casing 1341 may be provided with a slot portion 13411c, and the temperature sensor 1360 is arranged in the slot portion 13411c. The sealing member 1343 described here can be pressed on the temperature sensor 1360 so that the temperature sensor 1360 can be maintained in a correct position and prevent the temperature sensor 1360 from unexpected position changes. In some examples, the width of the sealing member 1343 on one side near the temperature sensor 1360 is greater than the width of the seal on the other side to better press against the temperature sensor 1360.

As shown in FIG. 20, in some examples, a buffer element 1370 may be provided between the main body 1310 and the vacuum motor 1330. The buffer element 1370 can absorb the vibration generated when the vacuum motor 1330 is working, to reduce the vibration transmission between the vacuum motor 1330 and the main body 1310, and reduce the vibration and noise when the vacuum motor 1330 is working. The type of the cushioning element 1370 can be determined according to actual needs, and can be of types such as elastic pads, sponges, etc., which are not limited in the embodiments of the present disclosure.

In some examples, a buffer element 1370 may be provided between the vacuum motor 1330 and the heating air outlet assembly 1340. The buffer element 1370 can absorb the vibration generated when the vacuum motor 1330 is working, to reduce the vibration transmission between the vacuum motor 1330 and the heating air outlet assembly 1340, and reduce the vibration and noise when the vacuum motor 1330 is working, and prevent the heating air outlet assembly 1340 from falling off due to shaking due to vibration or incorrect air supply. The type of the cushioning element 1370 can be determined according to actual needs, and can be of types such as elastic pads, sponges, etc., which are not limited in the embodiments of the present disclosure.

In some examples, a buffer element 1370 may be provided between the main body 1310 and the heating air outlet assembly 1340. For example, the buffer element 1370 can be arranged at the contact position between the main body 1310 and the heating air outlet assembly 1340, such as around the air outlet on the main body 1310, and the air outlet is used to carry the heating air outlet assembly 1340; and for example, the buffer element 1370 may be arranged at a fastening screw hole of the main body 1310 or the heating air outlet assembly 1340. The fastening screw hole is used to securely install the heating air outlet assembly 1340 at the air outlet of the main body 1310. The buffer elements 1370 provided around the air outlet of the main body 1310 and at the fastening screw holes of the main body 1310 or the heating air outlet assembly 1340 can reduce the indirect vibration transmission of the vacuum motor 1330 through the heating air outlet assembly 1340, thereby reducing vibration and noise. The type of the cushioning element 1370 can be determined according to actual needs, and can be of types such as elastic pads, sponges, etc., which are not limited in the embodiments of the present disclosure.

A brief introduction to typical application examples is given here.

As shown in FIGS. 13 to 17 and 19, the cleaning apparatus 13100 includes a main body 1310, a sewage bucket 1320, a vacuum motor 1330, a heating air outlet assembly 1340 and a roller brush 1350.

The main body 1310 is provided with a suction port 1311 and a fluid channel 1312. The suction port 1311, the fluid channel 1312 and the input end of the sewage bucket 1320 are connected in sequence, and the air outlet end 1321 of the sewage bucket 1320 is directly connected to the air inlet end 1331 of the vacuum motor 1330. The axial direction of the vacuum motor 1330 is parallel to the forward direction of the main body 1310; the suction port 1311 is arranged on the front area of the main body 1310 along its forward direction, the air inlet end 1331 of the vacuum motor 1330 is arranged on the front side of the vacuum motor 1330 along the forward direction of the main body 1310, and the air inlet end 1331 of the vacuum motor 1330 is arranged below the air outlet end 1321 of the sewage bucket 1320.

The main body 1310 is provided with a roller brush installation portion 1313. The roller brush 1350 is arranged on the roller brush installation portion 1313. The axial direction of the roller brush 1350 is parallel to the width direction of the main body 1310. The heating air outlet assembly 1340 includes an air outlet casing 1341 and a heater 1342 arranged on the air outlet casing 1341. One side of the air outlet casing 1341 is connected to the air outlet 133 of the vacuum motor 1330, and the other side forms an air outlet portion 13411; the heater 1342 takes the form of a PTC heater 1342 and is arranged between the air outlet 133 of the vacuum motor 1330 and the air outlet portion 13411. Here, the suction port 1311, the roller brush 1350 and the air outlet portion 13411 of the air outlet casing 1341 are located on the same side of the main body 1310.

The orthographic projection of the air outlet portion 13411 of the heating air outlet assembly 1340 in the first plane is the first projection. The first projection includes a first arc segment, a straight line segment and a second arc segment that are smoothly connected in sequence. The air outlet portion 13411 of the air outlet casing 1341 is deflected in a direction away from the roller brush installation portion 1313, and the included angle between the straight line segment and the forward direction of the main body 1310 is 5 to 20°, for example, 8°. In the two opposite ends of the air outlet portion 13411 provided along the width direction of the main body 1310, the air outlet holes 13411a at either end are configured to discharge air in a direction away from the other end, and the air outlet holes 13411a so configured at either end can be multiple; and the included angle between the extension direction of any side wall 13411b and the width direction of the main body 1310 is 55-65°, for example, 60°.

When cleaning the area to be cleaned, the cleaning apparatus 13100 can move in the forward direction; during the movement, the water spray portion of the cleaning apparatus 13100 sprays clean water or cleaning liquid on the surface of the area to be cleaned, and the roller brush 1350 performs cleaning and scrubbing on the surface of the area; under the negative pressure of the vacuum motor 1330, the sewage generated during the scrubbing process can be sucked into the sewage bucket 1320 through the suction port 1311 for recovery. At the same time, the vacuum motor 1330 discharges the air to the heating air outlet component 1340. The heater 1342 heats the air to generate hot air. The air outlet portion 13411 blows the hot air downward and to the left and right sides to the surface cleaned by the roller brush 1350 to quickly dry the area.

As shown in FIGS. 21 to 23, the embodiment of the present disclosure provides a cleaning apparatus 21100. The cleaning apparatus 21100 includes a main base 21101, a roller brush 21103 and a roller brush installation structure, which can reduce the vibration and noise of the roller brush 21103 during high-speed rotation. Here, the X direction, the Y direction and the Z direction can be defined as follows: the X direction and the Y direction are two directions orthogonal to each other in the horizontal plane, and the Z direction can be a vertical upward direction. The working scenario in which the main base 21101 moves on the horizontal ground and the roller brush 21103 rotates around the horizontal axis to sweep or clean the horizontal ground is explained. The X direction can be the forward direction of the main base 21101, and the Y direction can be the axial direction of the roller brush 21103.

The main base 21101 has a first installation portion 2111 and a second installation portion 2112 that are oppositely arranged. The first end of the roller brush 21103 is installed on the first installation portion 2111, and the second end of the roller brush 21103 is installed on the second installation portion 2112 through the roller brush mounting structure, the first end and the second end of the roller brush 21103 are the two opposite ends of the roller brush along the axial direction, and the second end of the roller brush 21103 is any one of the two opposite ends of the roller brush along the axial direction. Preferably, when the roller brush motor is arranged externally, the second end of the roller brush 21103 is the end of the roller brush 21103 away from the roller brush driving transmission portion; or when the roller brush motor is arranged internally, the second end of the roller brush 21103 is the end of the roller brush 21103 away from the built-in roller brush motor. Here, the main base 21101 can adopt the structure of the main base 21101 of different types of cleaning device such as sweeping robots, mopping robots, sweeping and mopping integrated robots, vacuum cleaners, cleaning machines, glass cleaning robots, etc., according to actual application needs, to achieve corresponding cleaning effects, which is not limited in the embodiments. The roller brush 21103 can adopt various types of roller brush bodies suitable for rotation according to the application requirements of the cleaning apparatus 21100.

The roller brush installation structure includes a handle 21102. The handle 21102 includes a body connection portion 2121 and an elastic handle portion 2122 connected each other. The body connection portion 2121 is configured to be connected to the second end of the roller brush 21103, and the elastic handle portion 2122 can be elastically deformed in the first plane, and is interference-connected or separated from the second installation portion 2112 in an elastically deformed state. The first plane is perpendicular to the axial direction of the roller brush 21103. Correspondingly, the radial direction of the roller brush 21103 is parallel to the first plane. In this way, the elastic deformation direction of the elastic handle portion 2122 is located in the first plane, so that when the elastic handle portion 2122 is in an elastic deformation state and is interference-connected with the second installation portion 2112 of the main base 21101, the acting force between the elastic handle portion 2122 and the second installation portion 2112 is parallel to the radial direction of the roller brush 21103.

In the related art, one end of some roller brushes is connected to the roller brush motor in a transmission way, and the other end is simply movable connected through the detachable structure with the main base of the cleaning device, so that the detachable structure cannot be correctly positioned and clamped, and the transmission connection end of the roller brush is subject to a greater binding force and the other end is subject to a smaller binding force; in this way, the axis of the roller brush is prone to large bends and radial translations, causing axis deviation, making the radial runout of the roller brush increases, and the roller brush is prone to cause large simple harmonic vibrations due to eccentricity when rotating. The roller brush collides with the main base and causes large noise. At the same time, the vibration is transmitted to the main base and causes the main base to vibrate. In addition, during the working process, the roller brush will rotate and rub against the dirt on the surface of the area to be cleaned, so that the roller brush may be subject to radial and tangential forces. The radial force and tangential force will cause the roller brush to move radially causing radial translation of the axis, and at the same time, the uneven restraint force at both ends of the roller brush further aggravates the axial bending of the roller brush, causing the axis deviation of the roller brush to increase, the vibration amplitude and the noise to increase, while the radial movement of the roller brush will cause insufficient contact between the roller brush and the dirt, making the cleaning device ineffective. Generally speaking, related technologies have problems such as reduced service life of roller brushes, poor cleaning of cleaning device, and noise pollution. In addition, the detachable structure of some roller brushes also has the problem of complex structure.

In the first aspect of the cleaning apparatus 21100 provided by the embodiment of the present disclosure, when the roller brush 21103 needs to be installed on the main base 21101, the second end of the roller brush 21103 can be arranged on the body connection portion 2121 first, and the first end of the roller brush 21103 can be arranged on the first installation portion 2111, and then the elastic handle portion 2122 is elastically deformed in the first plane and gradually comes into contact with the second installation portion 2112 to achieve the interference-connection, so that the roller brush 21103 can be reliably held on the main base 21101. On the contrary, the elastic handle portion 2122 can be elastically deformed in the first plane and separated from the second installation portion 2112, so that the roller brush 21103 can be detached from the main base 21101, and the disassembly and assembly are more convenient; secondly, the interference connection between the elastic handle portion 2122 and the second installation portion 2112 in the elastic deformation state allows the elastic handle portion 2122 to adjust itself to the correct position in the first plane based on the restraining force of the transmission connection end of the roller brush 21103 and maintain the position, so that the restraining force on both ends of the roller brush 21103 is more balanced, and the roller brush 21103 can be maintained in the correct position, thereby reducing the axis deviation of the roller brush 21103 including axis bending and axial radial translation, and the radial jump of the roller brush 21103, thereby reducing the large vibration and noise caused by the vibration caused by the radial jump of the roller brush 21103, reducing the service life shortens of the roller brush 21103 and the noise pollution of the cleaning apparatus 21100; in the third aspect, the elastic deformation of the elastic handle 2122 can be used to absorb the radial movement impact energy that may be generated by the roller brush 21103 during high-speed rotation, thereby reducing the vibration transmission and noise of the roller brush 21103 during the high-speed rotation process, and reducing the service life shortens of the roller brush 21103 and the noise pollution of the cleaning apparatus 21100; in the fourth aspect, when the roller brush 21103 comes into contact with the dirt on the surface of the area to be cleaned, the elastic deformation state maintained by the elastic handle 2122 can be used to reduce the radial movement of the roller brush 21103, so that the roller brush 21103 fully contacts the dirt and increases the cleaning efficiency of the cleaning device. To sum up, the handle 21102 of the cleaning apparatus 21100 provided by the embodiment of the present disclosure can simultaneously realize quick assembly and disassembly and positioning and clamping along the radial direction of the roller brush 21103. The integrated structure achieves both effects, and the structure is simple and compact; when the main base 21101 moves is horizontal ground and the roller brush 21103 rotates around the horizontal axis to sweep or clean the horizontal ground, the vibration of the roller brush 21103 along the forward and backward movement direction of the main base 21101 and in the vertical direction can be reduced.

In some embodiments, an elastic connection portion 2123 may be provided on the side of the body connection portion 2121 away from the roller brush 21103. The elastic connection portion 2123 is configured to be elastically deformable in a second plane; the second plane is parallel to the axis direction of the roller brush 21103, so that the elastic connection portion 2123 can be elastically deformed along the axial direction of the roller brush 21103. Here, the main base 21101 may be provided with a third installation portion 2113 on one side of the second installation portion 2112, and the elastic connection portion 2123 may be elastically deformed in the second plane to be interference-connected or separated from the third installation portion 2113. On the one hand, when the roller brush 21103 needs to be installed on the main base 21101, the second end of the roller brush 21103 can be arranged on the body connection portion 2121, and the first end can be arranged on the first installation portion 2111, and then the elastic connection portion 2123 is elastically deformed in the second plane and gradually comes into contact with the third installation portion 2113 to achieve the interference-connection, so that the roller brush 21103 can be reliably held on the main base 21101 along its axial direction. Conversely, the elastic connection portion 2123 can be elastically deformed in the second plane to separate from the third installation portion 2113, so that the roller brush 21103 can be detached from the main base 21101, making disassembly and assembly more convenient; on the other hand, the elastic connection portion 2123 can elastically deform and adaptively adjust to the correct position along the axial direction of the roller brush and maintain the position, which plays the role of positioning and clamping the roller brush 21103 along the axial direction of the roller brush 21103, which can reduce the roller brush axial movement due to the axial dimensional error, the end face runout and assembly errors, etc., thereby reducing the large vibration and noise caused by the vibration caused by the axial movement of the roller brush, reducing the service life shortens of the roller brush 21103 and the noise pollution of the cleaning apparatus 21100. Supplementary explanation, when the main base 21101 moves on the horizontal ground and the roller brush 21103 rotates around the horizontal axis to clean or wash the horizontal ground, the axial direction of the roller brush 21103 can be parallel to the horizontal plane and perpendicular to the forward and backward movement direction of the main base 21101.

Based on the elastic handle portion 2122 and the elastic connection portion 2123, the cleaning apparatus 21100 provided by the embodiment of the present disclosure can enable the user to quickly install and disassemble the roller brush 21103, and at the same time realize the positioning and clamping in radial and axial direction of the roller brush 21103, to reduce radial and axial vibration and noise. It achieves two effects with an integrated structure, and the structure is simple and compact. When the main base 21101 moves on the horizontal ground and the roller brush 21103 rotates around the horizontal axis to clean or wash the horizontal ground, the three-way vibration, i.e., the forward and backward movement direction of the main base 21101, the vertical direction and the axis direction of the roller brush 21103 can be reduced. The material of the elastic connection portion 2123 can be determined according to actual needs, and can be of types such as elastic plastic, metal springs, elastic rubber, etc., which are not limited in the embodiment of the present disclosure. For example, the elastic connection portion 2123 can be made of metal material, which is easy to process and has good elastic life.

The structure of the elastic connection portion 2123 can be determined according to actual needs, and elastic structures such as springs, elastic sheets, elastic pads, etc. can be used, which are not limited in the embodiments of the present disclosure. As shown in FIGS. 21 to 24, in some examples, the elastic connection portion 2123 may include a base body sub-portion 21231 and a spring piece sub-portion 232 connected to each other. The spring piece sub-section 232 has a connection end and a free end arranged oppositely, and the connection end and the base body sub-portion 21231 are connected. There is a gap between the free end and the base body sub-portion 21231. Here, the base body sub-portion 21231 can be connected to the body connection portion 2121, and the free end of the elastic piece sub-portion 232 can be elastically deformed in the second plane around the connection end to generate an elastic force along the axial direction of the roller brush 21103 to achieve positioning and clamping.

For example, the free end of the elastic piece sub-portion 232 can protrude from the side of the base body sub-portion 21231 away from the roller brush 21103; in this way, the free end of the elastic piece sub-portion 21232 can be first connected with the third installation portion 2113 when the roller brush 21103 is installed, which ensures the elastic deformation of the elastic piece sub-portion 21232 to achieve positioning and clamping. For example, the side of the free end of the elastic piece sub-portion 21232 away from the roller brush 21103 has an arc-shaped surface structure, which can make smooth contact between the free end of the elastic piece sub-section 21232 and the third installation portion 2113, thereby reducing contact wear. For example, the free end of the elastic piece sub-portion 21232 can be recessed in a direction away from the roller brush 21103; in this way, the free end of the elastic piece sub-portion 21232 forms a depression on the side close to the roller brush 21103, which can play a certain avoidance role and avoid assembly interference occurred.

The structure of the third installation portion 2113 can be determined according to actual needs, and is not limited in this embodiment of the disclosure. In some examples, the third installation portion 2113 may be a connection surface formed on the main base 21101 on one side of the second installation portion 2112.

The structure of the second installation portion 2112 can be determined according to actual needs, and can adopt types such as bosses, grooves, positioning post arrays, etc., which are not limited in the embodiments of the present disclosure. As shown in FIGS. 25 to 27, in some embodiments, the second installation portion 2112 may include two flange portions 21121 that are oppositely arranged, and the elastic handle portion 2122 is elastically deformed and held between the two flange portions 21121 to form the interference connection, and the elastic handle portion 2122 is limited and held by the two flange portions 21121. In some examples, the axial direction of the roller brush 21103 is parallel to the horizontal plane; accordingly, the force exerted by each flange portion 21121 on the corresponding elastic handle portion 2122 can be tilted upward, that is, the force has an acute angle with the horizontal plane, which can provide support along the front and rear movement direction of the main base 21101 and along the vertical direction.

In some examples, the second installation portion 2112 may further include two buckle portions 21122 arranged oppositely. Each buckle portion 21122 is disposed opposite to one flange portion 21121. Each buckle portion 21122 is configured to press the elastic handle portion 2122 to a flange portion 21121 opposite to the buckle portion 21122. The buckle portion 21122 is located above a corresponding flange portion 21121. In this way, the second installation portion 2112 forms a four-point limit for the elastic handle portion 2122, so that the degrees of freedom of the elastic handle portion 2122 along each radial direction of the roller brush 21103 are constrained, and the positioning and clamping of the roller brush 21103 along the radial direction is achieved and the vibration damping noise reduction effect is achieved as well. For example, the axial direction of the roller brush 21103 is parallel to the horizontal plane; accordingly, the force exerted by each flange portion 21121 on the corresponding elastic handle portion 2122 can be tilted upward, and the force exerted by each buckle portion 21122 on the corresponding elastic handle portion can be tilted downward to achieve complete positioning constraints along the forward and backward movement direction of the main base 21101 and along the vertical direction.

In some embodiments, the elastic handle portion 2122 can be elastically deformed along a first direction and a second direction arranged orthogonally, and the first direction and the second direction are respectively located in the first plane. In this way, the elastic handle 2122 can produce elastic deformation along each radial direction of the roller brush 21103. On the one hand, the roundness error of the roller brush 21103 can be compensated to a certain extent, thereby reducing the radial jump of the roller brush 21103 and the radial vibration resulted thereby, on the other hand, the radial kinetic energy that may be generated by the roller brush 21103 during the high-speed rotation process can be absorbed, the vibration transmission and noise of the roller brush 21103 during the high-speed rotation process is reduced accordingly.

The structure of the elastic handle 2122 can be determined according to actual needs, and is not limited in this embodiment of the disclosure. In some embodiments, the elastic handle portion 2122 may include two elastic arm portions 221 relatively disposed on the body connection portion 2121. The two elastic arm portions 21221 can be elastically deformed to approach or move away from each other in the first plane. In some examples, the two elastic arm portions 21221 can be elastically deformed in a first plane to approach each other to clamp the second installation portion 2112 located between the two elastic arm portions 21221, or be elastically deformed away from each other in the first plane to release the second installation portion 2112. In other examples, the two elastic arm portions 21221 can be elastically deformed away from each other in the first plane to press against the second installation portion 2112 located outside the two elastic arm portions 21221, or elastically deformed can be elastically deformed in a first plane to approach each other to separate from the second installation portion 2112.

In some examples, the elastic arm 21221 may have a fixed end and a free end formed at opposite ends thereof. Here, the fixed end is fixedly connected to the body connection portion 2121, and the free end can be lifted by the user. For example, a distance between the free ends of the two elastic arms 21221 may be smaller than a distance between the fixed ends of the two elastic arms 21221, so that the user can more easily pinch and pull the free ends of the two elastic arms 21221, to allow the two elastic arm portions 21221 to elastically deform. The structure of the elastic arm 21221 can be determined according to actual needs, which is not limited in this embodiment of the disclosure.

In some examples, the elastic arm portion 21221 can have a multi-fold arm structure, which can achieve elastic deformation in multiple directions and provide deformation forces in different directions. Here, the folding number of the multi-fold arm structure can be determined according to actual needs which is not limited in the embodiments of the present disclosure. For example, the multi-fold arm structure includes three sub-arm segments connected in sequence, and one end of the previous sub-arm segment is connected to one end of the subsequent sub-arm segment. For example, the included angle between two adjacent sub-arm segments is an acute angle.

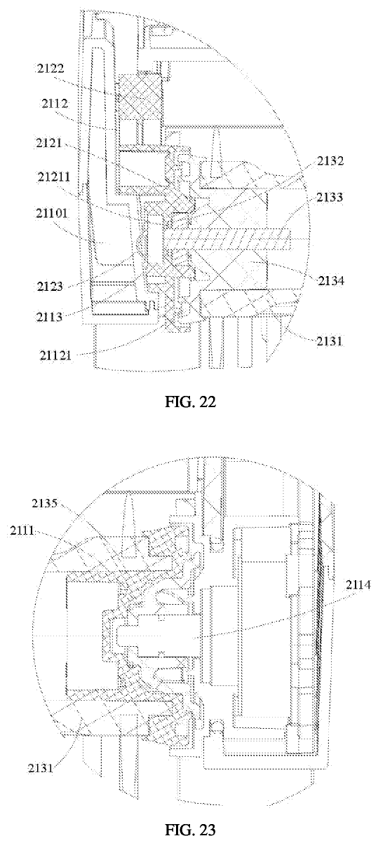

As shown in FIGS. 21-22, in some embodiments, the body connection portion 2121 may be provided with a first installation cavity 21211, and the roller brush 21103 may include a roller brush body 2131 and a bearing 2132 provided at one end of the roller brush body 2131. The bearing 2132 is installed in the first installation cavity 21211. The bearing 2132 can increase the coaxiality of the roller brush body 2131 after assembly and reduce the radial runout and radial vibration of the roller brush 21103. In some examples, the inner ring of the bearing 2132 can be interference-connected to the end of the roller brush 21103 away from the coupling 14, and the outer ring of the bearing 2132 can be connected to the first installation cavity 21211 using methods such as interference fit, clearance fit, or transition fit. and other different ways of cooperation. For example, the first installation cavity 21211 may be an installation hole.

In some examples, the roller brush 21103 may also include a roller brush shaft 2133. One end of the roller brush shaft 2133 is embedded inside the roller brush body 2131 and the other end protrudes outside the roller brush body 2131. The bearing 2132 is arranged on one end of the roller brush shaft 2133 protruding outside the roller brush body 2131. For example, the first installation cavity 21211 may have a stepped hole structure, the bearing 2132 is arranged in the counterbore portion of the stepped hole, and the roller brush shaft 2133 may penetrate the through hole portion of the stepped hole. In some examples, the roller brush 21103 can also be arranged on the first end cap 2134 and the second end cap 2135 at two ends of the roller brush body 2131, and the body connection portion 2121 can be connected to the first end cap 2134 through the bearing 2132.

In some examples, the body connection portion 2121 may also be provided with a second installation cavity 21212, and the first installation cavity 21211 is located inside the second installation cavity 21212. For example, the outer ring of the bearing 2132 can have a clearance fit with the first installation cavity 21211, and the second installation cavity 21212 can be connected and fixed with the first end cover plate 2134. For example, the second mounting cavity 21212 may be a mounting hole.

As shown in FIGS. 21 and 23, in some embodiments, taking the roller brush motor installed externally as an example, the main base 21101 may also include a coupling 2114, and the coupling 2114 is used to transmit the driving force of the roller brush motor. Here, the second end cap 2135 can be connected through the coupling 2114, and the roller brush motor drives the roller brush body 2131 to rotate through the coupling 2114. Correspondingly, the first installation portion 2111 may be formed on the coupling 2114.

In some embodiments, the cleaning apparatus 21100 may also include the aforementioned roller brush 21103. One end of the roller brush 21103 is arranged on the first installation portion 2111 and the other end is arranged on the body connection portion 2121.

As shown in FIGS. 28-29, in the second aspect, the embodiment of the present disclosure provides a roller brush assembly. The roller brush assembly includes a roller brush 21103 and a roller brush installation structure, which can reduce the vibration and noise of the roller brush 21103 during high-speed rotation. The roller brush assembly can be installed and disassembled on the main body 21101 of the cleaning apparatus 21100. After being installed in place, the area to be cleaned can be cleaned or washed by the rotation of the roller brush 21103. Here, the roller brush installation structure includes a handle 21102, and the handle 21102 includes a body connection portion 2121 and an elastic handle portion 2122 that are connected to each other. The body connection portion 2121 is connected to one end of the roller brush 21103, and the elastic handle portion 2122 is configured to be elastically deformable in the first plane. The structures of the body connection portion 2121 and the elastic handle portion 2122 can be referred to the foregoing introduction, which will not be described again here. Here, the roller brush 21103 and the handle 21102 can be assembled into an integral product, which can be directly assembled on the main base 21101 of different cleaning device.

As shown in FIGS. 21 to 29, in a third aspect, the embodiment of the present disclosure provides a handle 21102, which includes a body connection portion 2121 and an elastic handle portion 2122. The body connection portion 2121 is configured to connect with one end of the roller brush 21103, the elastic handle portion 2122 is configured to be elastically deformable in a first plane, and the first plane is perpendicular to the axial direction of the roller brush 21103. The structure of the body connection portion 2121 and the elastic handle portion 2122 can be referred to the foregoing introduction, and will not be described again here. Of course, in another embodiment, the first plane and the axial direction of the roller brush 21103 can also be arranged at an angle.

Here, a brief introduction to several typical application examples is given.

### Application Example One

As shown in FIGS. 21 to 27, the cleaning apparatus 21100 includes a main base 21101, a roller brush 21103, and a roller brush installation structure. Here, a working scenario in which the main base 21101 moves on a horizontal ground and the roller brush 21103 rotates around a horizontal axis to clean or wash the horizontal ground will be described. The forward and backward movement direction of the main base 21101 is the front and rear direction, the axis direction of the roller brush 21103 is the left and right direction, and the vertical up and down direction is the up and down direction.

The main base 21101 is provided with a first installation portion 2111, a second installation portion 2112, a third installation portion 2113, and a coupling 2114. The first installation portion 2111 may be formed on the coupling 2114 for connecting with one end of the roller brush 21103. The first installation portion 2111 and the second installation portion 2112 are arranged oppositely in the left-right direction. Based on the forward direction of the main base 21101, the first installation portion 2111 is located on the left side of the second installation portion 2112, the left end of the roller brush 21103 is installed on the first installation portion 2111, and the right end of the roller brush 21103 is installed on the second installation portion 2112. The second installation portion 2112 has a right wall, a front wall, a rear wall and a bottom wall. The front wall, the bottom wall and the rear wall of the second installation portion 2112 protrude from the left surface of the right wall to the left. The front wall, the bottom and the rear wall are connected in sequence and are arranged on the periphery of the left surface of the right wall, while the upper and left sides of the second installation portion 2112 remain open. The front wall and the rear wall are arranged obliquely, and a distance between the bottom of the front wall and the bottom of the rear wall is less than a distance between the top of the front wall and the top of the rear wall. The walls of the front wall and the rear wall respectively form a flange portion 21121, and the upper end of the front wall and the upper end of the rear wall respectively form a buckle portion 21122. The buckle portion 21122 is located above the corresponding flange portion 21121. The buckle portion 21122 and the flange portion 21121 of the front wall protrude from the wall surface of the front wall toward the rear wall. The buckle portion 21122 and the flange portion 21121 of the rear wall protrude from the wall surface of the rear wall toward the front wall. The protruding height of the buckle portion 21122 is greater than that of the flange portion 21121. That is, the distance from the top of the buckle portion 21122 to the wall surface is greater than the distance from the top of the flange portion 21121 to the wall surface. The third installation portion 2113 is arranged on the left surface of the right wall of the second installation portion 2112.

The handle 21102 includes a body connection portion 2121 and an elastic handle portion 2122 that are connected to each other. One side of the body connection portion 2121 is provided with a first installation cavity 21211 and the other side of which is provided an elastic connection portion 2123. The elastic connection portion 2123 is a metal elastic piece. The elastic connection portion 2123 may include a base body sub-portion 21231 and a spring piece sub-portion 21232 connected to each other. The elastic piece sub-portion 21232 has a connection end and a free end arranged oppositely. The connection end of the elastic connection portion 2123 and the base body sub-portions 21231 are connected, the free end of the elastic connection portion 2123 has a gap with the base body sub-portion 21231, and the free end protrudes from the side of the base body sub-portion 21231 away from the roller brush 21103. The elastic handle portion 2122 includes two elastic arm portions 21221 arranged oppositely; each elastic arm portion 21221 has a three-fold arm structure, and the three-fold arm structure includes a first fold arm connected to the body connection portion 2121, a second fold arm connected to the first fold arm and a third fold arm connected to second fold arm. The third fold arm is the free end of the elastic handle portion 2122. The first fold arm is arranged obliquely and abuts the front wall and the rear wall of the second installation portion 2112. The distance between the bottom ends of the two first fold arms is less than the distance between the top ends of the two first fold arms. The included angle between the first fold arm and the second fold arm is an acute angle, and the included angle between the second fold arm and the third fold arm does not exceed 90°. The front wall and the rear wall of the second installation portion 2112 are arranged obliquely, and the flange portions 21121 on the front and rear walls exert an oblique upward force on the abutting handle 21102. At the same time, the first fold arm of the handle 21102 is arranged obliquely, which is beneficial to the deformation of the handle 21102 and allows the user to save more effort when exerting force on the free end of the handle 21102.

When the roller brush 21103 needs to be installed on the main base 21101, the bearing 2132 at one end of the roller brush 21103 and the first installation cavity 21211 can be installed first, so that the handle 21102 and the roller brush 21103 are connected as one. Then, the other end of the roller brush 21103 is connected to the coupling 2114; then, the elastic handle 2122 is pinched to elastically deform, and the elastically deformed elastic handle 2122 is pressed downward into the second installation portion 2112, the elastic handle portion 2122 rebounds after being pressed into place, so that the two first fold arms of the elastic arm portion 21221 respectively abut the front wall and the rear wall of the second installation portion 2112 and abut against the two protrusions. The two buckle portions 21122 press against the upper surfaces of the two second fold arms, so that the elastic handle portion 2122 presses against the two flange portions 21121 and the two buckle portions 21122 respectively, so that the elastic handle portion 2122 is held in the second installation portion 2112 in interference fit, and the roller brush 21103 can be positioned and held on the main base 21101 along the radial direction; during the pressing process, the elastic connection portion 2123 gradually contacts the third installation portion 2113 and undergoes elastic deformation, so that the elastic connection portion 2123 and the third installation portion 2113 are interference-connected, and the roller brush 21103 can be reliably held on the main base 21101 along its axial direction.

When the roller brush 21103 needs to be removed from the main base 21101, the elastic handle 2122 can be pinched to further deform, and the elastically deformed elastic handle 2122 can be lifted upward and pulled out from the second installation portion 2112; at the same time, the elastic handle portion 2122 gradually elastically deforms and separates from the third installation portion 2113.

When the cleaning apparatus 21100 is working, the roller brush 21103 rotates at a high speed driven by the roller brush motor to clean or scrub the dirt on the horizontal ground. During this process, dirt will exert force on the roller brush 21103, causing the roller brush 21103 to have a radial movement tendency in the front-rear direction and up-down direction, and an axial movement tendency in the left-right direction. Since the elastic deformation state maintained by the elastic handle portion 2122 can reduce the radial movement of the roller brush 21103, the elastic deformation state maintained by the elastic connection portion 2123 can reduce the axial movement of the roller brush 21103, the position change of the roller brush 21103 may be reduced, making the roller brush 21103 be fully contacted with the dirt to increase the cleaning efficiency of the cleaning device, and the moving impact kinetic energy of the roller brush 21103 is absorbed by the elastic handle portion 2122 and the elastic connection portion 2123 respectively, reducing the vibration conduction and noise during the high-speed rotation process of the roller brush 21103.

### Application Example Two

As shown in FIGS. 28-29, the roller brush assembly includes a roller brush 21103 and a handle 21102. The roller brush 21103 and the handle 21102 are assembled to form an integral product. In this way, the roller brush assembly can be integrally installed on the main base 21101 of the cleaning apparatus, making it easy to replace and install.

The roller brush 21103 includes a roller brush body 2131, a bearing 2132, a roller brush shaft 2133, a first end cap 2134 and a second end cap 2135. The roller brush body 2131 can be provided with short pile or bristles accordingly to clean the area to be cleaned. One end of the roller brush shaft 2133 is embedded inside the roller brush body 2131, and the other end protrudes outside the roller brush body 2131. The first end cap 2134 and the bearing 2132 are arranged on one end of the roller brush shaft 2133 that protrudes outside the roller brush body 2131.

The handle 21102 includes a body connection portion 2121 and an elastic handle portion 2122 that are connected to each other. One side of the body connection portion 2121 is provided with a first installation cavity 21211 and another side of which is provided with an elastic connection portion 2123. The bearing 2132 can be installed in the first installation cavity 21211, so that the handle 21102 and the roller brush 21103 are connected and fixed. The elastic connection portion 2123 is a metal elastic piece with an opposite connection end and a free end. The connection end of the elastic connection portion 2123 is connected to the base body sub-portion 21231, and the free end of the elastic connection portion 2123 protrudes from the side of the base body sub-portion 21231 away from the roller brush 21103. The elastic handle portion 2122 includes two elastic arm portions 21221 arranged oppositely. Each elastic arm portion 21221 has a three-fold arm structure, and the included angle between the two adjacent sub-arm sections is an acute angle.

For the disassembly and assembly process of the roller brush assembly on the main base 21101, please refer to Application Example 1, which will not be described again here.

The present disclosure provides a cleaning device. The cleaning device includes a body and a collection apparatus arranged on the body. The collection apparatus can filter and collect dust, hair or other solids sucked by the cleaning device, and is not easily blocked by solids.

The collection apparatus includes a negative pressure channel and a filter assembly. The negative pressure channel can form an air flow. The filter assembly is arranged in the negative pressure channel and can filter the air flow.

The body is also provided with a container. In one embodiment, the negative pressure channel may be arranged inside the container as an internal structure of the container. For example, the negative pressure channel is surrounded by the inner wall of the container; or the negative pressure channel and the container are two independent components. The negative pressure channel can be connected to the container by welding or other methods. For example, it can be arranged in the middle position of the container, it can also be arranged at the edge of the container, or at any other position of the container.

In another embodiment of the present disclosure, the negative pressure channel can be arranged outside the container, such as installed or formed on the body of the cleaning device. When the container is installed on the body of the cleaning device, the channel in the container communicates with the negative pressure.

In one embodiment of the present disclosure, the negative pressure channel is an air outlet channel of the collection apparatus. The sucked solid and liquid dirt is collected in the collection apparatus, and air is taken away through the motor assembly through the air outlet channel of the collection apparatus.

The filter assembly is provided with multiple through holes to filter solids carried by the airflow. The extension direction of the filter assembly is consistent with the extension direction of the negative pressure channel, and the through holes are arranged along the extension direction of the filter assembly itself. A filter cavity is formed inside the filter assembly, and a collection cavity is formed between the outer wall of the filter assembly and the inner wall of the negative pressure channel. The filter cavity and the collection cavity are communicated through the through hole provided on the filter assembly. The collection cavity is used to collect the solid material after being filtered by the filter assembly.

The filter assembly includes a first end and a second end. The collection cavity includes an open end close to the first end of the filter assembly and a closed end close to the second end of the filter assembly. The open end of the collection cavity communicates with the negative pressure channel. The airflow in the negative pressure channel flows along the direction from the first end to the second end of the filter assembly. The airflow enters the collection cavity from the open end, flows toward the closed end of the collection cavity, and enters the filter cavity through the through hole of the filter assembly, so that solids carried by the airflow accumulate in the closed end area of the collection cavity.

The solids accumulated in the closed end area of the collection cavity only block the through holes near the second end of the filter assembly, and the airflow can still pass through the unblocked through holes of the filter assembly. As the solids accumulated, the area of solid accumulation gradually extends from the closed end to the open end. Before covering the through hole at the first end of the filter assembly, the filter assembly will not be completely blocked, and the airflow can still flow into the filter cavity through the unblocked through hole, thereby avoiding the decrease in suction caused by poor air flow and ensuring the cleaning effect.

In an embodiment of the present disclosure, the shape and structure of the container may be regular or irregular. The container may adopt an integrated structure or a split structure in which at least two parts are connected. When the container adopts a split structure, the various parts of the container should be sealed and connected. Those skilled in the art can adaptively set the shape and structure of the container according to actual structural settings or assembly needs, which will not be limited in this disclosure.

In one embodiment of the present disclosure, the negative pressure channel and the container are separated into two parts, that is, a negative pressure pipe is provided inside the container. The negative pressure pipe can be fixed by welding or other methods well known to those skilled in the art. On the inner wall of the container, the above-mentioned negative pressure channel is formed inside the negative pressure pipe.

The cleaning device, the collection apparatus and the filter assembly of the present disclosure will be described in detail below with reference to the accompanying drawings.

In one embodiment of the present disclosure, as shown in FIG. 30, the negative pressure channel 3010 is provided inside the container 301, and the container 301 is provided with an inlet and an outlet of the negative pressure channel 3010. Specifically, the container 301 has an inner cavity, and the inlet of the negative pressure channel 3010 is communicated with the inner cavity of the container 301, so that negative pressure can be formed in the inner cavity of the container 301 through the negative pressure channel 3010. The airflow can enter from the inlet of the negative pressure channel 3010, pass through the filter assembly 302, and then leave from the outlet of the negative pressure channel 3010. In detail, the inlet and outlet of the negative pressure channel 3010 can be arranged at two end areas in the extension direction of the negative pressure channel 3010. The first end 3021 of the filter assembly 302 faces the inlet of the negative pressure channel 3010, and the second end 3022 faces the outlet of the negative pressure channel 3010.

The side wall of the filter assembly 302 and the inner wall of the negative pressure channel 3010 form a collection cavity 3011. The position of the collection cavity 3011 adjacent to the first end 3021 of the filter assembly 302 is an open end communicated to the negative pressure channel 3010, and the position of second end 3022 adjacent to the filter assembly 302 forms a closed end. According to the principle of aerodynamics, airflow will preferentially flow along areas with less resistance. That is, when the airflow flows from the inlet to the outlet in the negative pressure channel 3010, it will preferentially flow along the area with less resistance. When the airflow flows to the first end 3021 of the filter assembly 302, due to the obstruction of the filter assembly 302, the airflow will preferentially enter the collection cavity 3011 along the open end of the collection cavity 3011 and flow towards its closed end along the extension direction of the collection cavity 3011. When the airflow flows to its closed end, it will flow through the through hole and enter the filter cavity 3023 of the filter assembly 302, and solid waste will accumulate at the closed end of the collection cavity 3011.

When the airflow flows along the extension direction of the collection cavity 3011, part of the airflow will enter the filter cavity 3023 of the filter assembly 302 through the through holes, but this does not affect the airflow direction of most of the airflow, and the solid waste carried by the airflow will still flow along the extension direction of the collection cavity 3011. This allows the solid waste to gradually accumulate at the closed end of the collection cavity 3011, and when the solid waste blocks the through holes of the filter assembly 302 adjacent to the closed end, the airflow can still enter the filter cavity from the through holes at other positions on the filter assembly 3023, and flows out from the outlet of the negative pressure channel 3010, thereby ensuring the fluidity of the air flow and avoiding the decrease in suction in the negative pressure channel 3010.

The flow rate of the airflow in the collection cavity 3011 is related to the space size of the collection cavity 3011. The smaller the space, the faster the flow rate. In one embodiment of the present disclosure, as shown in FIG. 1, the radial size of the collection cavity 3011 between the outer wall of the filter assembly 302 and the inner wall of the container 301 gradually decreases from the open end to the closed end. On the one hand, this facilitates the airflow entering the collection cavity 3011 from the open end. On the other hand, the flow rate of the airflow in the collection cavity 3011 can be gradually increased so that the airflow in the collection cavity 3011 makes the carried solids to be accumulated at the closed end.

The structure of the collection cavity 3011 is formed by the inner wall of the container 301 and the outer wall of the filter assembly 302. For example, the inner wall of the container 301 and the outer wall of the filter assembly 302 gradually approach each other from the open end to the closed end; or, one of the inner wall of the container 301 and the outer wall of the filter assembly 302 gradually approaches the other from the open end to the closed end, so that the radial size of the collection cavity 3011 gradually decreases from the open end to the closed end.

The filter assembly 302 can be arranged in a box-shaped, cylindrical, rectangular, cylindrical or other structure or shape. The shape and structure of the filter assembly 302 may be regular or irregular. The filter assembly 302 may adopt an integrated structure or a split structure in which at least two components are connected.

In one embodiment of the present disclosure, as shown in FIGS. 30 and 31, the radial size of the filter assembly 302 gradually increases from the first end to the second end, approximately in a tower shape, so that the collection cavity 3011 is in a structure in which the radial size gradually decreases from the open end to the closed end, thus forming a large negative pressure at the closed end, causing the solids carried in the airflow to accumulate at the closed end.

In one embodiment of the present disclosure, as shown in FIG. 30, the position of the filter assembly 302 adjacent to the second end 3022 contacts the inner wall of the container 301 to form a closed end of the collection cavity 3011, and the first end 3021 extends internally the negative pressure channel 3010 of the container 301. The connection method between the filter assembly 302 and the container 301 includes but is not limited to snap connection, bonding, screw connection, integrated injection molding, etc. Preferably, the filter assembly 302 is detachably connected within the container 301 to facilitate maintenance and cleaning.

The filter assembly 302 can be arranged at the middle position of the negative pressure channel 3010, or can be offset from the middle position of the negative pressure channel 3010. The collection cavity 3011 between the outer wall of the filter assembly 302 and the inner wall of the container 301 can be an annular structure surrounding the filter assembly 302; or, the collection cavity 3011 can also be arranged on one or several sides of the filter assembly 302. For example, part of the outer wall of the filter assembly 302 is in contact with the inner wall of the container 301, and a collection cavity 3011 is formed between the remaining outer walls of the filter assembly 302 and the inner wall of the container 301.

The filter assembly 302 can be arranged at any position between the inlet and the outlet of the negative pressure channel 3010. In a preferred embodiment, the second end 3022 of the filter assembly 302 can be close to the outlet of the negative pressure channel 3010, so that the filter assembly 302 has more space to extend into the negative pressure channel.

In a specific embodiment of the present disclosure, as shown in FIG. 30, the second end 3022 of the filter assembly 302 is connected to the outlet position of the negative pressure channel 3010, so that the filter assembly 302 has more extension space and can facilitate the installation and removal of filter assembly 302.

In one embodiment of the present disclosure, as shown in FIGS. 30 and 31, the first end 3021 of the filter assembly 302 is closed and the second end 3022 forms an opening. The airflow entering the filter cavity 3023 through the through hole 3020 is configured to flow out from the opening of the second end 3022, so that the gas in the filter cavity 3023 can flow smoothly.

In one embodiment of the present disclosure, the filter assembly 302 includes a side wall and a top wall located at the first end 3021. The side wall and the top wall together surround and form a filter cavity 3023 with an opening at one end. The filter assembly of the present disclosure has a simple structure and is easy to process and manufacture. Specifically, the filter assembly 302 has a rectangular cross-section. The through hole 3020 may be distributed on the top wall of the first end 3021 of the filter assembly 302 and the surrounding side walls. The through hole 3020 can be arranged in a regular or irregular manner on the filter assembly 302. Of course, the through hole can also be arranged only on the side wall, which will not be described in detail here.

In a specific embodiment of the present disclosure, as shown in FIGS. 30 and 31, the radial size of the filter assembly 302 gradually increases from the first end 3021 to the second end 3022, the cross-section is a rectangular structure, and the outlet of the negative pressure channel 3010 is configured as a rectangular structure adapted to the structure of the second end 3022 of the filter assembly 302. When the user installs the filter assembly 302, the user first installs the first end 3021 of the filter assembly 302 from the outlet. Since the first end 3021 is relatively small, the filter assembly 302 may not correspond to the outlet angle, causing the failure assembly of the filter assembly 30. The filter assembly 302 needs to be adjusted to the correct angle and then installed again.

In one embodiment of the present disclosure, as shown in FIG. 31, in order to ensure that the outlet angle of the filter assembly 302 corresponds to that of the container 301 during installation, a fool-proof structure 3028 can be provided on the outer wall of the filter assembly 302. The fool-proof structure 3028 is configured to extend from the first end 3021 to the second end 3022 on the outer wall of the filter assembly 302. The fool-proof structure 3028 can be arranged on opposite sides of the filter assembly 302, so that when the filter assembly 302 is installed, if the installation angle between the filter assembly 302 and the negative pressure channel 3010 is wrong, the fool-proof structure 3028 will interfere with the inlet of the negative pressure channel 3010. Only when the installation angle is corresponding, the filter assembly 302 can be installed into the negative pressure channel 3010 of the container 301.

In one embodiment of the present disclosure, the fool-proof structure 3028 is a plate-like structure arranged on the side wall of the filter assembly 302, and the plate-like structure is arranged at a position of the filter assembly 302 adjacent to the first end 3021. In another embodiment of the present disclosure, the plate-like structure is on the side wall of the filter assembly 302 and extends from a position adjacent to the first end 3021 toward the second end 3022.

Of course, for those skilled in the art, the fool-proof structure 3028 can also adopt other shapes, which will not be introduced in detail here.

In one embodiment of the present disclosure, as shown in FIG. 31, a limit flange 3024 is provided on the edge of the second end 3022 of the filter assembly 302, the second end 3022 of the filter assembly 302 is provided at the outlet position of the negative pressure channel 3010, and the limit flange 3024 is in contact with the outer edge of the outlet of the container 301 to limit the position of the filter assembly 302.

In one embodiment of the present disclosure, as shown in FIG. 30, an inwardly extending extension portion 3012 is provided on the inner wall of the negative pressure channel 3010 adjacent to the outlet. The extension portion 3012 and the second end 3022 of the filter assembly 302 surround and form the closed end of the collection cavity 3011. The extension portion 3012 may be provided around the inside of the opening, or may be provided in a partial area inside the opening. Those skilled in the art can adaptively set the shape and structure of the extension portion 3012 according to actual structural settings or assembly needs.

In one embodiment of the present disclosure, as shown in FIGS. 30 and 31, a limit buckle 3025 is provided on the side wall of the filter assembly, and the limit buckle 3025 is in contact with the end surface of the extension portion 3012 away from the outlet limiting the filter assembly 302 to prevent the filter assembly 302 from being separated from the outlet of the container 301. The limit buckle 3025 can be a convex structure formed by the outer wall of the filter assembly 302 extending outward and being integrally connected with the filter assembly 302; or the limit buckle 3025 can also be connected to the filter assembly 302 by bonding, snapping, welding, etc. On the filter assembly 302. At least one limit buckle 3025 is provided. When multiple limit buckles 3025 are provided, they can be evenly distributed on the outer wall of the filter assembly 302.

In one embodiment of the present disclosure, as shown in FIGS. 30 and 31, the filter assembly 302 includes a matching portion 3026 near its second end 3022, and a filter portion 3027 formed by the matching portion 3026 extending toward the first end 3021. The matching portion 3026 matches the inner wall of the extension portion 3012 in the outlet of the container 301. The through hole 3020 of the filter assembly 302 is opened in the filter portion 3027. In detail, the matching portion 3026 is located between the limit buckle 3025 and the limit flange 3024, and the matching portion 3026 and the extension portion 3012 surround and form a closed end of the collection cavity 3011.

In a specific embodiment of the present disclosure, the filter portion 3027 of the filter assembly 302 is configured to gradually increase in radial size from the first end 3021 to the second end 3022 to form a tapered structure, so that the space of the collection cavity 3011 gradually decreases from the open end to the closed end.

In an embodiment of the present disclosure, as shown in FIG. 31, a handle 303 is provided on the filter assembly 302. The handle 303 can be connected to the second end 3022 of the filter assembly 302 located at the outlet of the container 301, and the filter assembly 302 can be easily removed from the outlet of the container 301 through the handle 303. The handle 303 can be connected to the edge of the second end of the filter assembly 302; or it can be connected to the inside of the opening of the second end 3022; the handle 303 can also be connected to other positions on the second end 3022. The handle 303 can be set into any shape such as a rod-shaped structure, a U-shaped structure, an L-shaped structure, etc.

In a specific embodiment of the present disclosure, the handle 303 is configured as a rod-shaped structure and is connected inside the opening of the second end of the filter assembly 302. Two ends of the handle 303 are respectively connected to the inner wall of the opening of the second end 3022. The second end 3022 of the filter assembly 2 is arranged in a square structure, and the two ends of the handle 303 can be connected to the opposite or adjacent inner walls of the second end 3022. The handle 303 can be disposed at the middle position of the second end 3022, or the handle 303 can also be deviated from the middle position of the second end 3022 to reduce obstruction to the air flow.

The present disclosure also provides a cleaning device, which may be a vacuum cleaner, a carpet cleaning machine, a floor cleaning machine, a sweeping robot, etc. The cleaning device includes a machine body and the above-mentioned collection apparatus, and the collection apparatus is installed on the machine body. The machine body can suck dust and other solid matter from the outside into the collection apparatus. The collection apparatus may be a sewage tank, and the container 301 is the body of the sewage tank. The sewage generated by the cleaning device during the cleaning work can be sucked into the sewage tank along with the air flow. The sewage and the air flow can be separated in the sewage tank, and the air flow enters the negative pressure channel 3010.

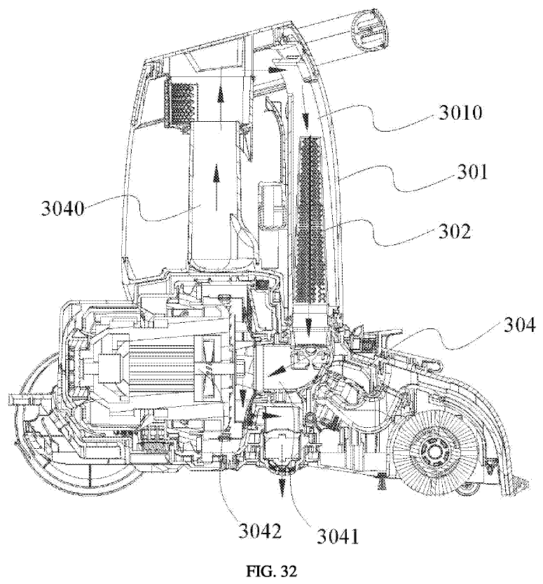

In a specific embodiment of the present disclosure, referring to FIG. 32, a cleaning apparatus, such as a roller brush, a rag, etc., may be provided on the body 304. The body 304 is also provided with a sewage extraction channel, which can extract sewage left after cleaning by the cleaning apparatus into the container 301 for storage. Referring to FIG. 32, a sewage inlet channel 3040 is also provided in the inner cavity of the container 301. The sewage inlet channel 3040 is communicated with the sewage suction channel provided on the body 304, so that the sewage left after cleaning by the cleaning apparatus can enter the inner cavity of the container 301 for storage through the sewage suction channel and the sewage inlet channel 3040 provided in the container 301.

As shown in FIG. 32, an air outlet channel 3041 can be provided on the body 304. One end of the air outlet channel 3041 is connected to the outlet of the negative pressure channel 3010, and the other end is connected to the outside of the body 304. The airflow discharged from the outlet of the negative pressure channel 3010 can be discharged to the outside of the body 304 through the air outlet channel 3041.

The body 304 is also provided with a motor assembly 3042. The motor assembly 3042 is disposed in the passage of the air outlet channel 3041. The motor assembly 3042 is configured to provide negative pressure to the air outlet channel 3041. Specifically, the impeller of the motor assembly 3042 can be disposed in the air outlet channel 3041, and the airflow at the outlet of the negative pressure channel 3010 flows to the motor assembly 3042, and is discharged from the body 304 after passing through the motor assembly 3042. The closer the distance is to the motor assembly 3042, the greater the negative pressure generated by the motor assembly 3042 and the faster the air flow speed. The second end 3022 of the filter assembly 302 is relatively close to the motor assembly 3042, and the negative pressure of the negative pressure channel 3010 at the second end 3022 of the filter assembly 302 is greater than the negative pressure at the first end 3021. Therefore, the closed end of the collection cavity 3011 can form a relatively large negative pressure, which is conducive to the accumulation of solids in the air flow at the closed end of the collection cavity 3011.

The sewage suction channel provided on the body 304, the sewage inlet channel 3040 provided in the container 301, the inner cavity of the container 301, the negative pressure channel 3010, and the air outlet channel 3041 provided on the body 304 constitute the air duct system of the cleaning device. When the motor assembly 3042 is working, a negative pressure is formed in the inner cavity of the container 301 through the air outlet channel 3041 and the negative pressure channel 3010, so that the sewage near the cleaning apparatus can be extracted to the inner cavity of the container 301 through the sewage inlet channel 3040 and the sewage suction channel for storage. This air duct system is common knowledge among those skilled in the art and will not be described in detail here. During the cleaning process of the cleaning device of the present disclosure, when the sewage suction channel absorbs sewage, the solid waste will usually enter the inner cavity of the container 301 and be stored together with the sewage, and part of the solid waste will follow the airflow along the flow direction from the negative pressure channel 3010 to the air outlet channel 3041. When the solid waste enters the negative pressure channel 3010 with the air flow, it will gradually accumulate in the closed end area of the collection cavity 3011, thereby preventing the solid waste from entering the air outlet channel 3041 and damaging the motor assembly 3042.

During the drying process of the cleaning device of the present disclosure, water vapor and solid waste are extracted at the cleaning apparatus. The water vapor and solid waste will flow along the air duct system of the cleaning device. When the water vapor mixed with solid waste enters the negative pressure channel 3010, the solid waste will gradually accumulate in the closed end area of the collection cavity 23, and the airflow will enter the filter cavity of the filter assembly 302 through the through hole, and be discharged through the air outlet channel 3041 on the body 304.

The filter assembly of the present disclosure can not only be applied to the above-mentioned collection apparatus, but also can be applied to other adaptable scenarios. For this purpose, the present disclosure also provides a filter assembly, including the above-mentioned component. The filter assembly is configured for installation within the negative pressure channel of the container. The container may be the container of the collection apparatus described above.

Specifically, the extension direction of the filter assembly 302 is consistent with that of the negative pressure channel 3010. The filter assembly 302 has a plurality of through holes 3020 arranged along its extension direction, which can filter solids carried by the airflow. A filter cavity 3023 is formed inside the filter assembly 302, and a collection cavity 22 is formed between the outer wall of the filter assembly 302 and the inner wall of the container 301. The collection cavity 22 is used to collect the solids filtered by the filter assembly 302. The filter cavity 3023 and the collection cavity 22 are communicated through the through holes 3020 on the filter assembly 302.

The filter assembly 302 includes a first end 3021 and a second end 3022. The collection cavity 3011 includes an open end and a closed end. The open end is adjacent to the first end 3021 of the filter assembly 302 and is communicated to the negative pressure channel 3010. The closed end is adjacent to the second end 3022 of the filter assembly 302. The airflow in the negative pressure channel 3010 flows along the direction from the first end 3021 to the second end 3022 of the filter assembly 302, enters the collection cavity from the open end, flows toward the closed end of the collection cavity 3011, and passes through the through hole 3020 of the filter assembly 302 and enters into the filter chamber 3023, so that the solids carried by the air flow accumulate in the closed end area of the collection cavity 3011, blocking the through holes of this part of the filter assembly 302.

### Application Scenarios

When the collection apparatus is installed, the filter assembly 302 is installed into the negative pressure channel 3010 from the outlet on the container 301, and the first end 3021 of the filter assembly 302 is directed into the container 301. The limit flange 3024 of the second end 3022 of the filter assembly 302 can abut the outer edge of the outlet, and the limit buckle 3025 can abut the inner end surface of the inner extension 3012 of the container outlet, thereby limiting the installation position of the filter assembly 302. A collection cavity 3011 is formed between the outer wall of the filter assembly 302 and the inner wall of the container 301.

The negative pressure channel 3010 forms an airflow flowing from the first end 3021 to the second end 3022 of the filter assembly 302. The airflow can enter from the open end of the collection cavity 3011 and flow to the closed end of the collection cavity 3011, so that the solids carried by the airflow accumulate at the closed end, and the airflow enters the filter cavity 3023 from the through hole 3020 of the filter assembly 302, and then flows out from the opening of the second end 3022 of the filter assembly 302. Solids gradually accumulate in the collection cavity 3011, blocking the through holes 3020 of the filter assembly 302 adjacent to its second end 3022. The through holes 3020 of the filter assembly 302 are distributed in the extending direction from its first end 3021 to its second end 3022. Before the solid covers the through hole 3020 of the first end 3021 of the filter assembly 302, the filter assembly 302 will not be completely blocked, thereby maintaining the flow of the airflow.

1. A cleaning apparatus, including:
a main base having a first installation portion and a second installation portion arranged oppositely;
a roller brush, having a first end and a second end arranged oppositely, where the first end and the second end are the two ends on an axical direction of the roller brush, and the first end is installed on the first installation portion;
a roller brush installation structure, including a handle, where the handle includes a body connection portion and an elastic handle portion that are connected to each other, the body connection portion is connected to the second end of the roller brush, the elastic handle portion is elastically deformed and installed on the second installation portion, and a first plane is perpendicular or inclined at an angle relative to the axial direction of the roller brush.

2. The cleaning apparatus according to item 1, a side of the main body connection portion away from the roller brush is provided with an elastic connection portion, the main base is further provided with a third installation portion on a side of the second installation portion, the elastic connecting portion is elastically deformed and abuts the third installation portion in a second plane, and the second plane is parallel to the axial direction of the roller brush.

3. The cleaning apparatus according to item 1, the second installation portion includes two flange portions arranged oppositely, and the elastic handle portion is elastically deformed and held between the two flange portions.

4. The cleaning apparatus according to item 3, the second installation portion includes two buckle portions arranged oppositely, each of the buckle portions is arranged opposite to one corresponding flange portion, and each of the buckle portions presses the elastic handle portion toward one of the flange portions opposite to the buckle portion.

5. The cleaning apparatus according to item 4, the elastic handle portion includes two elastic arm portions arranged oppositely on the body connection portion, and the two elastic arm portions can be elastically deformed in the first plane to come into each other or to be separated from each other.

6. The cleaning apparatus according to item 5, the flange portion and the buckle portion contact and abut with the elastic arm portion.

7. The cleaning apparatus according to item 5, the elastic arm has a multi-fold arm structure; and/or the elastic arm has a fixed end and a free end formed at its opposite ends, and the fixed end and the body connection portion are fixedly connected.

8. The cleaning apparatus according to item 6, each of the elastic arm portions includes a first fold arm connected to the body connection portion, a second fold arm connected to the first fold arm, and a third fold arm connected to the second fold arm, the third fold arm is the free end of the elastic arm portion, the first fold arm is against the flange portion, and the buckle portion is against the upper surface of the second fold arm.

9. The cleaning apparatus according to item 2, the elastic connection portion includes a base body sub-portion and an elastic piece sub-portion, the elastic piece sub-portion has a connection end and a free end arranged oppositely, the connection end is connected to the base body sub-portion, and the free end is elastically deformable in the second plane around the connection end.

10. The cleaning apparatus according to item 9, the free end of the elastic piece sub-portion protrudes from a side of the base body sub-portion away from the roller brush; a side of the free end of the elastic piece sub-section away from the roller brush has an arc surface structure; and the free end of the elastic piece sub-section is recessed in the direction away from the roller brush.

11. A roller brush assembly, including:
a roller brush;
a handle, including a body connection portion and an elastic handle portion connected with each other, where the body connection portion is connected to one end of the roller brush, the elastic handle portion is configured to be elastically deformable in a first plane, and the first plane is perpendicular or inclined at an angle relative to the axial direction of the roller brush;
the elastic handle portion includes two elastic arm portions arranged oppositely on the body connection portion, and the two elastic arm portions can be elastically deformed in the first plane to come into each other or to be separated from each other.

12. A handle, including:
a body connection portion, configured to be connected to one end of a roller brush;
a elastic handle portion, configured to be elastically deformable in the first plane, including two elastic arm portions disposed oppositely on the body connection portion, where the two elastic arm portions can be elastically deformed in the first plane to come into each other or to be separated from each other, and the first plane is perpendicular or inclined at an angle relative to the axial direction of the roller brush.

13. A cleaning device, including a body and a collection apparatus installed on the body (304), where the collection apparatus includes:
a negative pressure channel;
a filter assembly, with a plurality of through holes arranged along an extending direction from a first end of which to a second end of which; where a filter cavity is formed inside the filter assembly;
a collection cavity is formed between a side wall of the filter assembly and an inner wall of the negative pressure channel; the collection cavity includes an open end adjacent to the first end of the filter assembly and communicated to the negative pressure channel, and a closed end adjacent to the second end (3022) of the filter assembly (302).

14. The cleaning device according to item 13, a radial size of the collection cavity (3011) gradually decreases from the open end to the closed end.

15. The cleaning apparatus according to item 13, a radial size of the filter assembly (302) gradually increases from the first end (3021) to the second end (3022).

16. The cleaning device according to item 13, the filter cavity (3023) forms an opening at the second end (3022) of the filter assembly (302), and an airflow entering the filter cavity (3023) through the through hole (3020) is configured to flow out from the opening of the second end (3022).

17. The cleaning device according to item 16, the filter assembly (302) includes a side wall and a top wall located at the first end (3021); the side wall and the top wall enclose a filter cavity (3023) with one end open.

18. The cleaning device according to item 16, a handle (303) is connected to the filter assembly (302), and the handle (303) is connected to the opening of the second end (3022) of the filter assembly (302).

19. The cleaning device according to item 13, the negative pressure channel (3010) has an inlet and an outlet; a limit flange (3024) is provided on an edge of the second end (3022) of the filter assembly (302), and the limit flange (3024) abuts the outer edge of the outlet.

20. The cleaning device according to item 19, an extension portion (3012) extending inwardly is provided on the inner wall of the negative pressure channel (3010) adjacent to the outlet, and the extension portion (3012) and the filter assembly (302) enclose the closed end of the collection cavity (3011).

21. The cleaning device according to item 20, a limit buckle (3025) is provided on the side wall of the filter assembly (302), and the limit buckle (3025) abuts one side of the end face of the extension portion (3012) away from the outlet.

22. The cleaning device according to item 20, the filter assembly (302) includes a matching portion (3026) close to its second end (3022), and the matching portion (3026) cooperates with the extension portion (3012); and the filter assembly (302) also includes a filter portion (3027) formed by the matching portion (3026) extending toward the first end (3021), and the through hole (3020) is opened on the filter portion (3027).

23. The cleaning device according to item 13, a fool-proof structure (3028) is provided on the outer wall of the filter assembly (302), and the fool-proof structure (3028) is configured to extend from the first end (3021) to the second end (3022) on the outer wall of the filter assembly (302).

24. The cleaning device according to item 13, the collection apparatus includes a container (301), and the negative pressure channel (3010) is provided in the container (301).

25. The cleaning device according to any one of items 13 to 24, a motor assembly (3042) and an air outlet channel (3041) are arranged inside the body (304), and one end of the air outlet channel (3041) is connected to the outlet of the negative pressure channel (3010); and the motor assembly (3042) is arranged in the passage of the air outlet channel (3041), and is configured to form a negative pressure in the air outlet channel (3041), so that the airflow in the negative pressure is discharged through the air outlet channel.

26. The cleaning device according to any one of items 13 to 24, the collection apparatus is a sewage tank, and the negative pressure channel (3010) is an air outlet pipe of the sewage tank.

27. A collection apparatus, including:
a negative pressure channel (3010);
a filter assembly (302), with a plurality of through holes arranged along an extending direction from a first end of which to a second end of which; where a filter cavity is formed inside the filter assembly;
a collection cavity (3011) is formed between a side wall of the filter assembly (302) and an inner wall of the negative pressure channel (3010); the collection cavity (3111) includes an open end adjacent to the first end (3021) of the filter assembly (302) and communicated to the negative pressure channel, and a closed end adjacent to the second end (3022) of the filter assembly (302).

28. A filter assembly, the filter assembly (302) is configured to be installed in a negative pressure channel (3010), an extension direction of the filter assembly (302) is consisting with an extending direction of the negative pressure channel (3010), and the filter assembly (302) has multiple through holes (3020) arranged along its extension direction;
a filter cavity (3023) is formed inside the filter assembly (302); the outer wall of the filter assembly (302) is configured to form a collection cavity (3011) with the inner wall of the negative pressure channel (3010);
the filter assembly (302) includes a first end (3021) and a second end (3022); the collection cavity (3011) includes an open end adjacent to the first end (3021) of the filter assembly (302) and communicated to the negative pressure channel, and a closed end adjacent to the second end (3022) of the filter assembly (302). an airflow is formed in the negative pressure channel (3010), and the airflow is configured to flow along the direction from the first end (3021) to the second end (3022) of the filter assembly (302), inter the filter chamber (3023) from the collection cavity (3011) through the through hole (3020), and the solids carried by the airflow accumulate in the closed end area of the collection cavity (3011).

Finally, it should be noted that the above-mentioned embodiments are only specific implementations of the present disclosure and are used to illustrate the technical solutions of the present disclosure rather than to limit them. The protection scope of the present disclosure is not limited thereto. Although the present disclosure is described in detail with reference to the foregoing embodiments, those of ordinary skill in the art should understand that any person familiar with the technical field can still modify the technical solutions recorded in the foregoing embodiments within the technical scope disclosed in the present disclosure, or changes may be easily imagined, or equivalent substitutions may be made to some of the technical features; and these modifications, changes or substitutions do not cause the essence of the corresponding technical solutions to deviate from the spirit and scope of the technical solutions of the embodiments of the present disclosure, and shall be included in the present disclosure. Therefore, the protection scope of the present disclosure should be determined by the protection scope of the claims.

1. A cleaning apparatus, comprising a main body, a vacuum motor and a heating air outlet assembly, wherein an axial direction of the vacuum motor is parallel to a forward direction of the main body, an air inlet end of the vacuum motor is arranged on one side of the vacuum motor facing the forward direction, and projections of the air inlet end of the vacuum motor and the heating air outlet assembly on a horizontal plane at least partially coincide.

2. The cleaning apparatus according to claim 1, wherein an axis of the air inlet end of the vacuum motor coincides with an axis of the heating air outlet assembly.

3. The cleaning apparatus according to claim 1, further comprising a sewage bucket, the air inlet end of the vacuum motor is arranged below an air outlet end of the sewage bucket, and the air inlet end of the vacuum motor has an elbow structure.

4. The cleaning apparatus according to claim 1, wherein the heating air outlet assembly comprises an air outlet casing and a heater arranged on the air outlet casing, one side of the air outlet casing is connected with the air outlet of the vacuum motor and another side forms an air outlet portion, and the heater is arranged between the air outlet of the vacuum motor and the air outlet portion.

5. The cleaning apparatus according to claim 4, wherein the air outlet of the vacuum motor is provided with an air outlet hood, the air outlet hood is connected with the air outlet and the heating air outlet assembly, to guide outlet air surrounding the air outlet vertically downward directing toward the heating air outlet assembly.

6. The cleaning apparatus according to claim 1, wherein the main body is provided with a roller brush installation portion, the air outlet portion of the heating air outlet assembly is arranged behind the roller brush installation portion in the forward direction of the main body, and the air outlet portion of the heating air outlet assembly is deflected in a direction away from the roller brush installation portion.

7. The cleaning apparatus according to claim 6, wherein an orthographic projection of the air outlet portion of the heating air outlet assembly in a first plane is a first projection, an included angle between a top of the first projection or a tangent line of the top and the forward direction of the main body is 5° to 20°, and the first plane is parallel to the forward direction of the main body and perpendicular to an extending direction of the roller brush installation portion.

8. The cleaning apparatus according to claim 7, wherein the included angle between the top of the first projection or the tangent line of the top and the forward direction of the main body is 7° to 10°.

9. The cleaning apparatus according to claim 4, wherein the air outlet portion comprises a plurality of air outlet holes arranged in an array, the air outlet portion has two opposite ends along a width direction of the main body, and the air outlet holes of at least one end are configured to discharge air in a direction away from the other end.

10. The cleaning apparatus according to claim 9, wherein an air outlet angle of the air outlet hole at one end of the air outlet portion is a first value, the air outlet angle of the air outlet hole at the other end of the air outlet portion is a second value, and the air outlet angle of the air outlet hole is an included angle between an air outlet direction of the air outlet hole and the width direction of the main body.

11. The cleaning apparatus according to claim 10, wherein the first value and the second value are equal fixed values;
or, the first value and the second value are unequal fixed values;
or, at least one of the first value and the second value gradually decreases in a direction away from the other end of the air outlet portion.

12. The cleaning apparatus according to claim 10, wherein the air outlet angle of the air outlet hole of at least one end is 45° to 85°.

13. The cleaning apparatus according to claim 12, wherein the air outlet angle of the air outlet hole of at least one end is 55° to 65°.

14. The cleaning apparatus according to claim 10, wherein a proportion of a sum of flow areas of the air outlet holes at either end of the air outlet portion in flow areas of the air outlet portion is a predetermined value.

15. The cleaning apparatus according to claim 4, wherein the air outlet has two side walls oppositely arranged in the width direction of the main body, and at least one side wall is configured to guide air away from the other side wall.

16. The cleaning apparatus according to claim 4, wherein the heating air outlet assembly further comprises a sealing member, and the sealing member is arranged between outer peripheral surfaces of both ends of the heater and the air outlet casing.

17. The cleaning apparatus according to claim 16, wherein the heated air outlet assembly further comprises a temperature sensor, the air outlet casing is provided with a slot portion, the temperature sensor is arranged in the slot portion, and the sealing member is pressed on the temperature sensor.

18. The cleaning apparatus according to claim 1, wherein a buffer element is provided between the vacuum motor and the heating air outlet assembly, and a buffer element is provided between the main body and the heating air outlet assembly.

19.-42. (canceled)
